(19) United States
(12) Patent Application Publication
(10) Pub. No.: US 2017/0041495 A1
(43) Pub. Date: Feb. 9, 2017

(54) PRINTER, PRINTING SYSTEM, AND PRINT MANUFACTURING METHOD

(71) Applicant: JVC KENWOOD CORPORATION, Yokohama-shi (JP)

(72) Inventor: Keiji IHARA, Yokohama-shi (JP)

(21) Appl. No.: 15/222,063

(22) Filed: Jul. 28, 2016

(30) Foreign Application Priority Data
Aug. 6, 2015 (JP) 2015-155672

(51) Int. Cl. H04N 1/32; B41J 2/325

(52) U.S. Cl. CPC H04N 1/32309; H04N 1/32325; H04N 1/32352; B41J 2/325; H04N 2201/0082; H04N 2201/3233

(57) ABSTRACT

An input unit receives first image data corresponding to a watermark image by a first glossy ink. An image data transmitter composes the first image data and data representing a basic transfer pattern as a background of the watermark image to create and send second image data representing a watermark composite image. The basic transfer pattern is configured to transfer the first ink so that first pixels to which the first ink is transferred and second pixels to which the first ink is not transferred are dispersedly mixed. A printing unit prints a third image based on third image data printed using a second ink on a print body and prints the watermark composite image based on the second image data using the first ink on the print body to form a watermarked image including the third image and the watermark composite image superimposed on the print body.

### CROSS REFERENCE TO RELATED APPLICATION

This application is based upon and claims the benefit of priority under 35 U.S.C. §119 from Japanese Patent Application No. 2015-155672 filed on Aug. 6, 2015, the entire contents of which are incorporated herein by reference.

### BACKGROUND

The present disclosure relates to a printer and a printing system which print a watermarked color image on a transfer body using metal ink, and a method of manufacturing print matter, including a watermarked color image printed using metal ink.

As a printer printing an image on a transfer body as a printing target, a retransfer device is used, which sublimates or fuses ink of an ink ribbon with a thermal head and transfers an image onto an intermediate transfer film. The printer again transfers and prints the transferred image onto a card. Japanese Patent No. 4337582 (Patent Document 1) describes such a retransfer device.

In the retransfer device, the ink ribbon includes ink layers of four colors including yellow (Y), magenta (M), cyan (c), and black (B), for example. The ink of each ink layer is sequentially transferred and superimposed on the intermediate transfer film to form a non-glossy color image. The formed non-glossy color image is again transferred and printed on a card, so that a color image is formed on the card.

There is another commonly-used technique to form a glossy color image on the surface of a card, by using an ink ribbon including an ink layer of metal ink showing metallic gloss instead of the black ink layer, or as an ink layer of the fifth color. The technique performs the same transfer and retransfer printing as described in Patent Document 1. The metal ink is usually referred to as silver ink.

The technique to form a glossy color image is described in Japanese Patent Publication No. 3373714 (Patent Document 2).

Hereinafter, objects on which images are to be printed are referred to as transfer bodies, and images formed on the transfer bodies are also referred to as formed images. An example of a transfer body is a card.

### SUMMARY

In a card with a glossy color image formed thereon, the glossy part looks different depending on the viewing direction because the intensity of reflected light varies by direction. Accordingly, by using the glossy part as a so-called watermark section, such glossy color cards can provide special effects (watermark effects), higher security, or other effects, and therefore can attract a lot of attention.

The watermark section on such glossy cards is visible from specific directions only called visible directions, which are substantially invisible from other directions, called invisible directions. The non-watermark section other than the watermark section is visible from all directions. The watermark effect refers to an effect that produces transition of the watermark section between the visible or invisible state, depending on the viewing direction.

According to the techniques described in Patent Documents 1 and 2, it is possible to provide a transfer body such as a card with a watermarked color image formed at a comparatively low cost. However, more improvements are required. The watermark effect cannot be sufficiently obtained depending on the lightness (density) of the non-watermarked part. Very few techniques have been conventionally examined to provide a better water effect.

A first aspect of the embodiments provides a printer including: an input unit configured to receive first image data corresponding to a watermark image by a first glossy ink; an image data transmitter configured to compose the first image data and data representing a basic transfer pattern as a background of the watermark image to create and send second image data representing a watermark composite image, the basic transfer pattern being configured to transfer the first ink so that first pixels to which the first ink is transferred and second pixels to which the first ink is not transferred are dispersedly mixed; and a printing unit configured to print a third image based on third image data printed using a second ink on a print body, and to print the watermark composite image based on the second image data using the first ink on the print body to form a watermarked image including the third image and the watermark composite image superimposed on the print body.

A second aspect of the embodiments provides a printing system including: a printer; and a printer driver configured to send image data to the printer, wherein the printer driver includes: an input unit configured to receive first image data corresponding to a watermark image by a first glossy ink; and an image data transmitter configured to compose the first image data and data representing a basic transfer pattern as a background of the watermark image to create and send second image data representing a watermark composite image, the basic transfer pattern being configured to transfer the first ink so that first pixels to which the first ink is transferred and second pixels to which the first ink is not transferred are dispersedly mixed; and the printer includes a printing unit configured to print a third image based on third image data printed using a second ink on a print body, and to print the watermark composite image based on the second image data using the first ink on the print body to form a watermarked image including the third image and the watermark composite image superimposed on the print body.

A third aspect of the embodiments provides a method of manufacturing a printed matter, including: receiving first image data corresponding to a watermark image by a first glossy ink; composing the first image data and data representing a basic transfer pattern as a background of the watermark image to create second image data representing a watermark composite image, the basic transfer pattern being configured to transfer the first ink so that first pixels to which the first ink is transferred and second pixels to which the first ink is not transferred are dispersedly mixed; and printing a third image based on third image data printed using a second ink on a print body and printing the watermark composite image based on the second image data using the first ink on the print body to manufacture the printed matter with a watermarked image formed thereon, the watermarked image including the third image and the watermark composite image superimposed on the print body.

### BRIEF DESCRIPTION OF THE DRAWINGS

FIG. 1 is a diagram illustrating the printer PR as Example 1 of a printer according to at least one embodiment.

FIG. 2 is a block diagram illustrating the configuration of the printer PR.

FIG. 3 is a plan view and a side view illustrating the ink ribbon 11 used in the printer PR.

FIG. 4 is a plan view and a side view illustrating the intermediate transfer film 21 used in the printer PR.

FIG. 5 is a view illustrating a pressure contact between the ink ribbon 11 and the intermediate transfer film 21 by the thermal head 16 of the printer PR.

FIG. 6 is a diagram illustrating the thermal head 16.

FIG. 7 is a diagram illustrating the transfer image information J3.

FIG. 8 is a flowchart illustrating operations of the color image data transmitter CT1 and the metal image data transmitter CT2.

FIG. 9 is a schematic diagram illustrating the basic transfer pattern PtS.

FIG. 10 is a schematic diagram illustrating the watermark transfer image Pt.

FIG. 11 is a schematic diagram illustrating the watermark transfer composite image PtG.

FIG. 12 is a table illustrating the transfer patterns CPA to CPE.

FIG. 13 is a diagram illustrating a component separation method using the transfer pattern CPB.

FIG. 14 is a first diagram illustrating an operation to transfer and form an intermediate image P on the intermediate transfer film 21.

FIG. 15 is a second diagram illustrating the operation to transfer and form the intermediate image P on the intermediate transfer film 21.

FIG. 16 is a third diagram illustrating the operation to transfer and form the intermediate image P on the intermediate transfer film 21.

FIG. 17 is a fourth diagram illustrating the operation to transfer and form the intermediate image P on the intermediate transfer film 21.

FIG. 18 is a first diagram illustrating the transferred state according to the transfer pattern CPB.

FIG. 19 is a second diagram illustrating the transferred state according to the transfer pattern CPB.

FIG. 20 is a fifth diagram illustrating the operation to transfer and form the intermediate image P on the intermediate transfer film 21.

FIG. 21 is a third diagram illustrating the transferred state according to the transfer pattern CPB.

FIG. 22 is a schematic cross-sectional view illustrating the intermediate image P formed on the intermediate transfer film 21.

FIG. 23 is a plan view illustrating the intermediate transfer film 21 after the intermediate image P is retransferred.

FIG. 24 is a schematic cross-sectional view illustrating the card 31 on which the image Pc is formed by retransfer of the intermediate image P.

FIG. 25 is a schematic cross-sectional view illustrating light reflected on metal ink in the image Pc formed on the card 31.

FIG. 26 is a first conceptual diagram illustrating the differences in appearance of the watermark transfer image Pt.

FIG. 27 is a second conceptual diagram illustrating the differences in appearance of the watermark transfer image Pt.

FIG. 28 is a first diagram illustrating the appearance of the watermark transfer image Pt.

FIG. 29 is a second diagram illustrating the appearance of the watermark transfer image Pt.

FIG. 30 is a third diagram illustrating the appearance of the watermark transfer image Pt.

FIG. 31 is a fourth diagram illustrating the appearance of the watermark transfer image Pt.

FIG. 32 is a fifth diagram illustrating the appearance of the watermark transfer image Pt.

FIG. 33 is a sixth diagram illustrating the appearance of the watermark transfer image Pt.

FIG. 34 is a block diagram illustrating the configuration of the printing system SY as Example 2.

### DETAILED DESCRIPTION

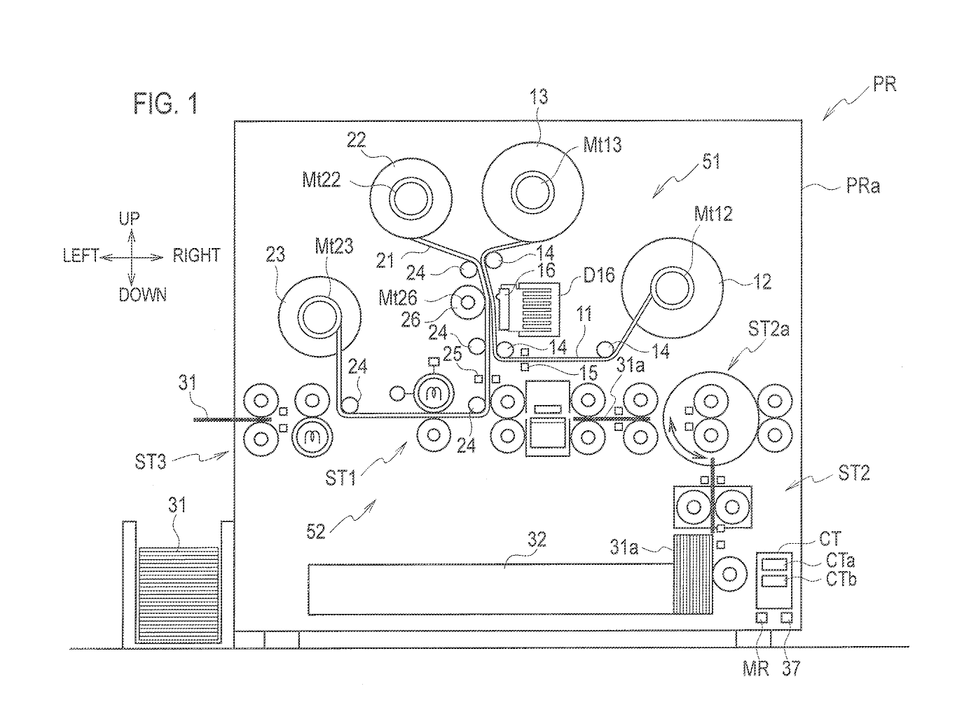

First, a description is given of the printer PR as Example 1 of a printer according to an embodiment with reference to FIGS. 1 to 33.

### Example 1

The printer PR in Example 1 is a retransfer printer, for example, a card printer which manufactures a so-called card as printed matter. As illustrated in FIG. 1, the printer PR includes the casing PRa, the transfer device 51, and the retransfer device 52. The transfer and retransfer devices 51 and 52 are accommodated in the casing PRa. The transfer and retransfer devices 51 and 52 constitute a printing unit.

The printer PR is configured to execute both transfer printing of a normal image with no watermark section, and transfer printing of a watermarked image with a watermark section.

The printer PR transfers ink of the ink ribbon 11 to the intermediate transfer film 21 as a transfer body (a print body) to form an image in the transfer device 51. The printer PR further retransfers the image transferred and formed on the intermediate transfer film 21 to the card material 31a as another transfer body, thus producing the card 31 with the image printed thereon.

The transfer device 51 is provided with the supply reel 12 and the take-up reel 13 for the ink ribbon 11, which are detachably attached to the transfer device 51.

The attached supply and take-up reels 12 and 13 are driven and rotated by the driving motors Mt12 and Mt13, respectively. The rotation speeds and directions of the motors Mt12 and Mt13 are controlled by the controller CT, which is provided for the printer PR.

The ink ribbon 11 is guided by the plural guide shafts 14, and is laid along a predetermined travel path between the supply and take-up reels 12 and 13. In the middle of the travel path of the ink ribbon 11, the ink ribbon sensor 15 is provided for cueing.

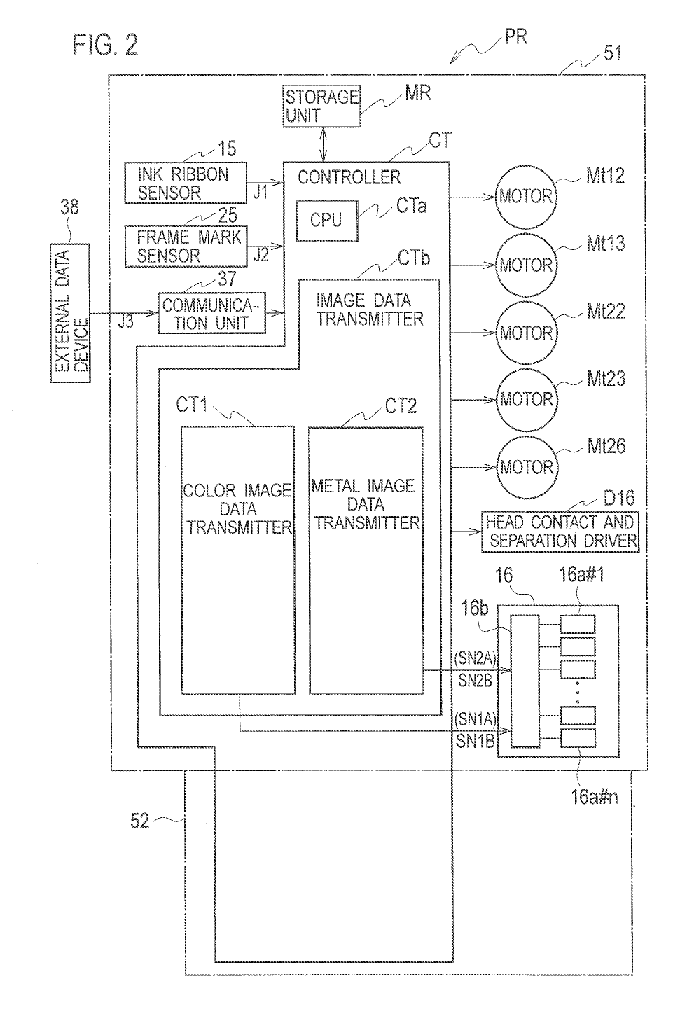

The ink ribbon sensor 15 detects the cue mark (not illustrated) of the ink ribbon 11, and sends the ribbon mark detection information J1 (refer to FIG. 2) to the controller CT.

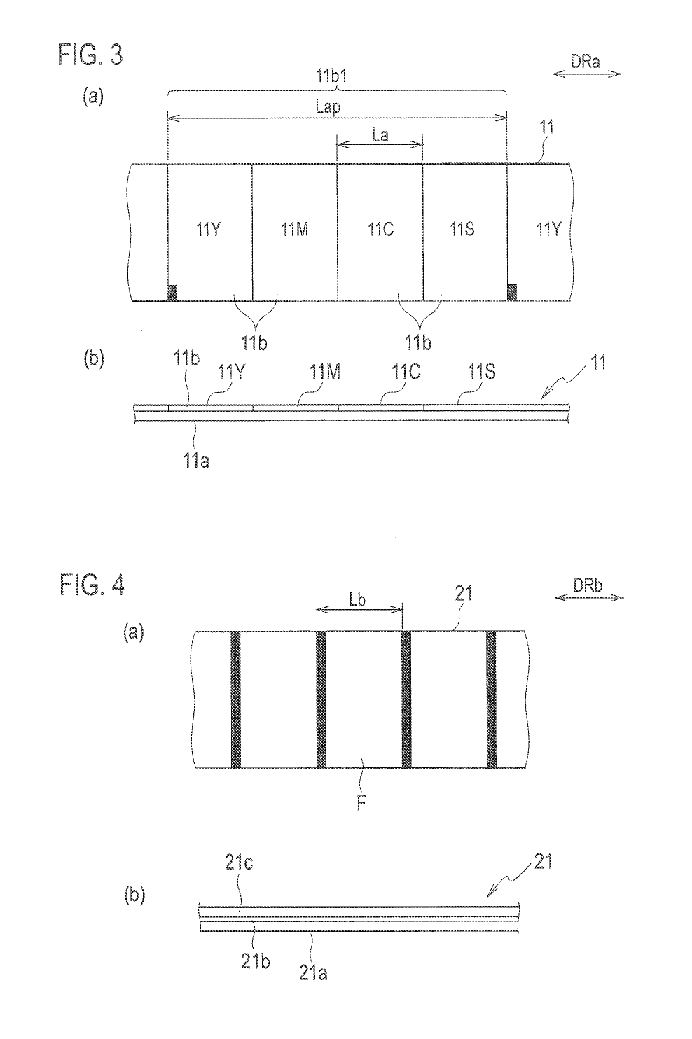

As illustrated in FIG. 3, the ink ribbon 11 includes the ribbon base 11a, an ink layer 11Y of yellow ink IY, an ink layer 11M of magenta ink IM, an ink layer 11C of cyan ink IC, and an ink layer 11S of metal ink, providing a glossy, metallic, silver color. The ink layers 11Y, 11M, 11C, and 11S are formed on one surface of the ribbon base 11a. The ink ribbon 11 is described in detail later. In the following description, each of the yellow ink IY, magenta ink IM, and cyan ink IC is referred to as a color ink.

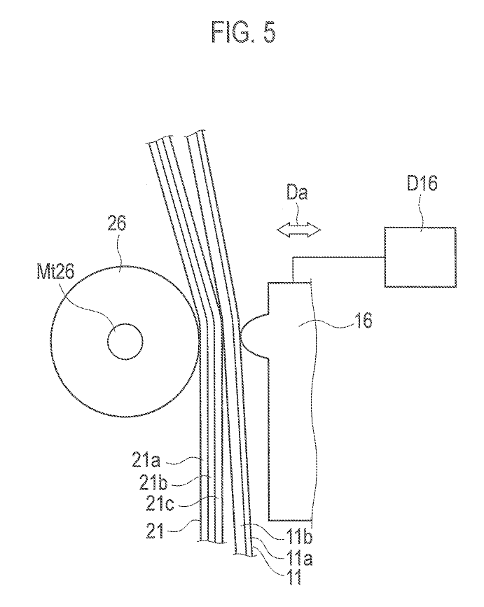

In FIG. 1, between the ink ribbon sensor 15 and the take-up reel 13 on the travel path of the ink ribbon 11, a thermal head 16 is provided. The thermal head 16 is configured to contact and separate from the surface (refer to FIG. 3) of the laid ink ribbon 11 on the ribbon base 11a side (in the direction of arrow Da of FIG. 5).

The contacting and separating operation of the thermal head 16 is executed by the head contact and separation driver D16 under control of the controller CT.

The transfer device 51 is provided with the supply reel 22 and the take-up reel 23 for the intermediate transfer film 21, which are detachably attached to the left of the loaded ink ribbon 11 in FIG. 1.

The attached supply and take-up reels 22 and 23 are driven and rotated by the driving motors Mt22 and Mt23, respectively. The rotation speeds and directions of the motors Mt22 and Mt23 are controlled by the controller CT.

The intermediate transfer film 21 is guided by the plural guide shafts 24, and is laid along a predetermined travel path between the supply and take-up reels 22 and 23. In the middle of the travel path of the intermediate transfer film 21, a frame mark sensor 25 is provided for cueing. The frame mark sensor detects frame marks of the intermediate transfer film 21, and sends the frame mark detection information J2 (refer to FIG. 2) to the controller CT.

The intermediate transfer film 21 transmits light. The frame mark sensor 25 is an optical sensor, for example. The frame marks are formed so as to block light, and the frame mark sensor detects the frame marks based on the difference between the transmission and the blocking of light.

Between the frame mark sensor 25 and the supply reel 22 on the travel path of the intermediate transfer film 21, a platen roller 26, which is driven and rotated by the motor Mt26, is provided. The rotation speed and direction of the motor Mt26 are controlled by the controller CT.

As illustrated in FIG. 5, the thermal head 16 contacts and separates from the ink ribbon 11 through the contacting and separating operation by the head contact and separation driver D16. The thermal head 16 and platen roller 26 need to relatively contact and separate from each other. The platen roller 26 may be configured to perform the operation of contacting and separating from the ink ribbon 11.

To be specific, the thermal head 16 moves between a pressure contact position (illustrated in FIG. 5) and a separation position (illustrated in FIG. 1). When at the pressure contact position, the thermal head 16 presses the ink ribbon 11 against the platen roller 26 to bring the intermediate transfer film 21 and the ink ribbon 11 into a pressure contact between the thermal head 16 and the platen roller 26. When at the separation position, the thermal head 16 is separated from the ink ribbon 11. A later-described transfer is performed while the thermal head 16 is located at the pressure contact position.

The ink ribbon 11 and the intermediate transfer film 21 are configured to be independently wound by the take-up reels 13 and 23 and rewound by the supply reels 12 and 22, while the thermal head 16 is located at the pressure contact position. These movements are executed through operations of the motors Mt12 and Mt13 and motors Mt22 and Mt23.

The ink ribbon 11 and the intermediate transfer film 21, being in close contact with each other, move together toward the supply reels 13 and 23, or the take-up reels 12 and 22. The movement is executed by rotation of the supply reels 12 and 22, the take-up reels 13 and 23, and the platen roller 26 driven by the motors Mt12, Mt13, Mt22, Mt23, and Mt26 under control of the controller CT.

As illustrated in FIGS. 1 and 2, the printer PR includes the controller CT, the storage unit MR, and the communication unit 37. The communication unit 37 functions as an input unit through which the printer PR receives externally-transmitted data and the like. The controller CT includes a central processing unit (CPU) CTa and an image data transmitter CTb. As illustrated in FIG. 2, the image data transmitter CTb includes a color image data transmitter CT1 and a metal image data transmitter CT2.

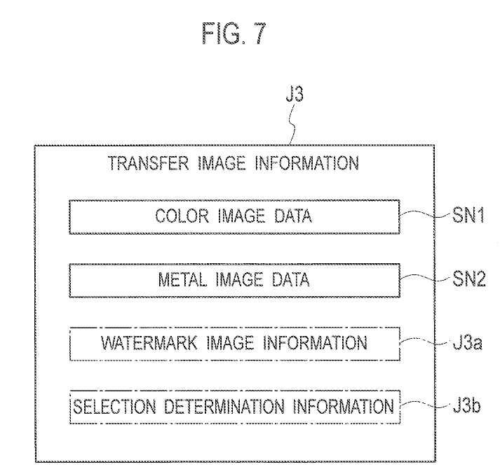

The controller CT is supplied with transfer image information J3 (refer to FIGS. 2 and 7) through the communication unit 37 from the external data device 38. The supplied transfer image information J3 is stored in the storage unit MR, and is referred to by the controller CT when needed.

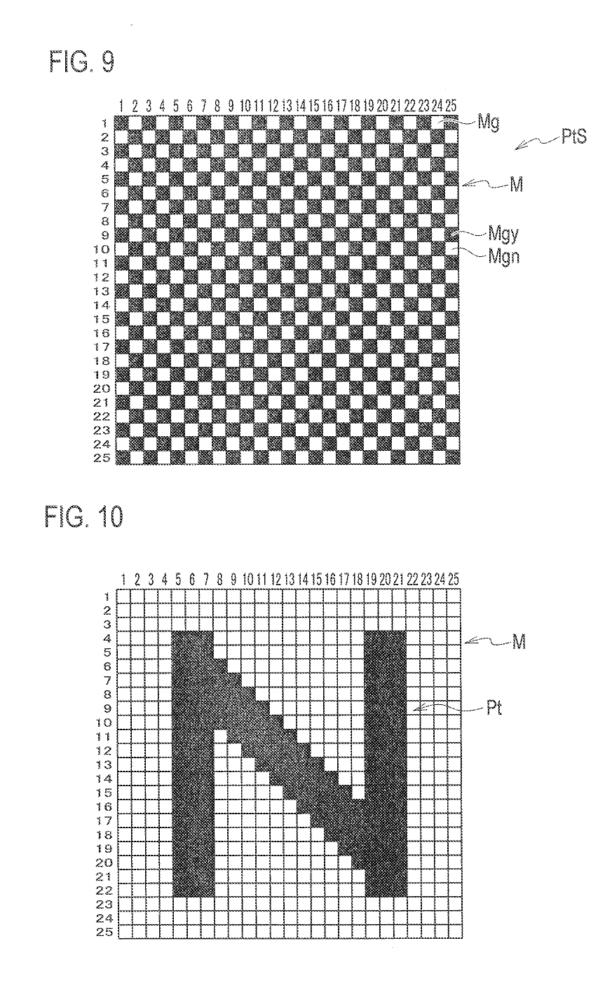

The storage unit MR previously stores an operation program for controlling the entire operation of the printer PR and the metal pattern data SNs as image data specifying a previously-configured basic transfer pattern PtS (refer to FIG. 9) of metal ink.

As illustrated in FIG. 7, the transfer image information J3 includes the color image data SN1 as image data of a non-glossy color image transferred with color ink, and the metal image data SN2 as image data of an image transferred with metal ink.

The image data transmitter CTb executes data creation and the like as follows when the metal image data SN2 does not include data of a watermark section. The image data transmitter CTb creates color transfer image data SN1A and metal transfer image data SN2A for transfer based on the color and externally supplied metal image data SN1 and SN2. The image data transmitter CTb then outputs the same to the thermal head 16.

The image data transmitter CTb executes data creation and the like as follows when the metal image data SN2 includes data of a watermark section. The image data transmitter CTb creates color the transfer image data SN1B and the watermark transfer image data SN2B for the transfer of a watermarked image based on the color, metal image data SN1 and SN2, and metal pattern data SNs. The image data transmitter CTb then outputs the same to the thermal head 16.

A more specific description thereof is given. In the case of transferring an image with no watermark section, the color image data transmitter CT1 creates the following image data based on the color image data SN1.

The color image data transmitter CT1 creates image data SN1y of an image to be transferred with the yellow ink IY of the ink layer 11Y, the image data SN1m of an image to be transferred with the magenta ink IM of the ink layer 11M, and the image data SN1c of an image to be transferred with the cyan ink IC of the ink layer 11C.

The color image data transmitter CT1 sends the created image data SN1y, SN1m, and SN1c as the color transfer image data SN1A to the thermal head 16.

In the case of transferring a watermarked image, the color image data transmitter CT1 creates the following image data based on the color image data SN1, and the metal pattern data SNs.

The color image data transmitter CT1 creates the image data SN1By of an image to be transferred with the yellow ink IY of the ink layer 11Y, the image data SN1Bm of an image to be transferred with the magenta ink IM of the ink layer 11M, and the image data SN1Bc of an image to be transferred with the cyan ink IC of the ink layer 11C.

The color image data transmitter CT1 sends the created image data SN1By, SN1Bm, and SN1Bc as the color transfer image data SN1B for a watermarked image to the thermal head 16. The method of creating the color transfer image data SN1B is described later.

When the transfer image is an image in which the watermark effect does not need to be emphasized (herein, referred to as a no-watermark section image), the metal image data transmitter CT2 does not create the watermark transfer image data SN2B for the watermarked image. In this case, based on the metal image data SN2, the metal image data transmitter CT2 creates the metal transfer image data SN2A for transferring only the glossy section with the metal ink. The metal image data transmitter CT2 sends the created image data SN2A to the thermal head 16.

When the transfer image is a watermarked image in which the watermark effect needs to be emphasized, the metal image data transmitter CT2 creates the watermark transfer image data SN2B for the transfer of metal ink based on the metal pattern data SNs and the metal image data SN2. The metal image data transmitter CT2 then sends the created image data SN2B to the thermal head 16. The method of creating the watermark transfer image data SN2B is described later.

The image data transmitter CTb supplies to the thermal head 16 at the proper timing, the color image data SN1A or SN1B and the metal transfer image data SN2A or watermark transfer image data SN2B, which are used for transfer to each transfer frame F (refer to FIG. 4, described later in detail) of the intermediate transfer film 21, when the thermal head 16 is located at the pressure contact position.

The color transfer image data SN1A and SN1B are data for transfer of the color ink. The metal transfer image data SN2A and the watermark transfer image data SN2B are data for transfer of the metal ink.

The timing at which the color transfer image data SN1A and SN1B, and metal and watermark transfer image data SN2A and SN2B are supplied is determined by the whole controller CT based on the frame mark detection information J2 and the like.

As illustrated in (a) and (b) of FIG. 3, the ink ribbon 11 includes the belt-shaped ribbon base 11a and the ink layers 11b, which are applied and formed on the ribbon base 11a. The ink ribbon 11 includes four types of ink layers as the ink layers 11b. The four types of ink layers are arranged in a predetermined order to constitute each ink group 11b1. The ink groups 11b1 are applied repeatedly in the longitudinal direction of the ink ribbon 11 (in the direction of arrow DRa).

To be specific, the ink group 11b1 includes the ink layer 11Y of the yellow ink IY, the ink layer 11M of the magenta ink IM, the ink layer 11C of the cyan ink IC, and the ink layer 11S of the metal ink, which are applied in this order in the longitudinal direction.

The yellow ink IY, magenta ink IM, and cyan ink IC are sublimation inks, and transmit light. The sublimation can be controlled by the amount of heat added by the thermal head 16, and the lightness and darkness in the transfer image can be represented by density levels.

The metal ink is a gray fusion ink, for example. The metal ink contains metal particles or flakes, and does not transmit light. The metal is aluminum or silver, for example.

The metal ink transferred section formed on the transfer body by transfer of the metal ink (substantially) specularly reflects the incident light with a high directivity. The metal ink transferred section is visually recognized as having a glossy, metallic silver color when the viewing direction is equal to the direction of reflection.

As illustrated in (a) and (b) of FIG. 4, the intermediate transfer film 21 includes the belt-shaped film base 21a, the release layer 21b, and the transfer image receiving layer 21c. The release layer 21b and the transfer image receiving layer 21c are laid on the film base 21a. The intermediate transfer film 21 is partitioned at regular intervals of pitches Lb as the frames F.

In the transfer device 51, the intermediate transfer film 21 and the ink ribbon 11 are laid so that the transfer image receiving layer 21c directly faces the ink layer 11b, as illustrated in FIG. 5.

The transfer image receiving layer 21c receives and fixes the inks of the ink layers 11Y, 11M, and 11C which are heated and sublimated, and the metal ink of the ink layer 11S which is heated and fused. When the thermal head 16 is in pressure contact with the ink ribbon 11 as illustrated in FIG. 5, the ink of the ink layer 11b, which is pressed against the transfer image receiving layer 21c, is transferred to form and print an image in the transfer image receiving layer 21.

In the transfer process, the color inks of the ink layers 11Y, 11M, and 11C are transferred according to a heating pattern corresponding to the color transfer image data SN1A or SN1B supplied to the thermal head 16. The metal ink of the ink layer 11S is transferred according to a heating pattern corresponding to the metal transfer image data SN2A, or watermark transfer image data SN2B supplied to the thermal head 16.

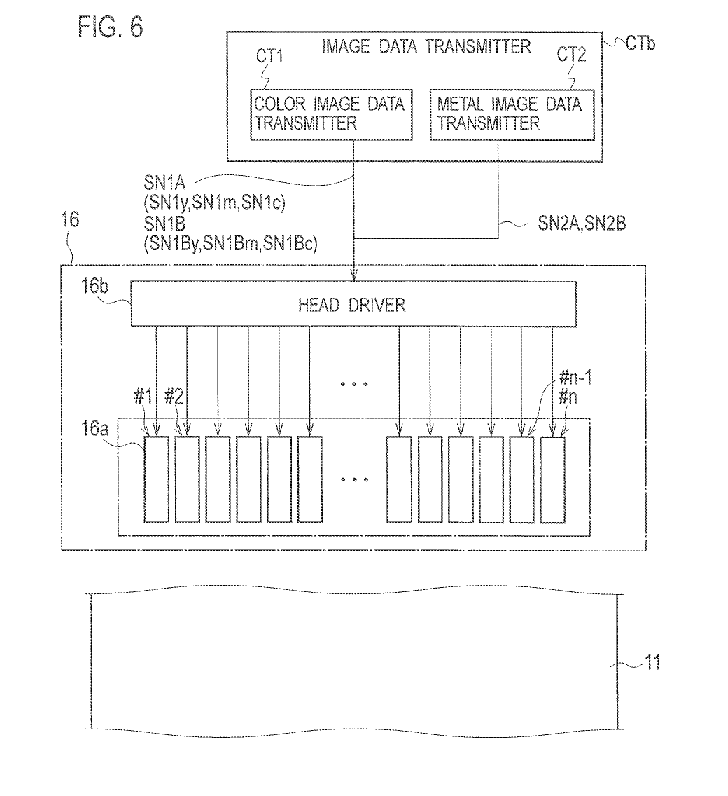

As illustrated in FIG. 6, the thermal head 16 includes n heating resistors 16a, arrayed in the width direction of the ink ribbon 11. The thermal head 16 includes the head driver 16b, which energizes the plural heating resistors 16a independently in accordance with the color and metal transfer image data SN1A and SN2A, or the color and watermark transfer image data SN1B and SN2B.

An image is formed with m×LNa (width×length) dots on the intermediate transfer film 21 as an image-formed body. Herein, LNa indicates the number of lines of the image to be transferred in the longitudinal direction. The number LNa corresponds to the number of lines that can be selectively energized. The m heating resistors 16 are successive ones selected from the n heating resistors 16a other than at least the heating resistor 16a located at an end.

When the printer PR forms an image of 300 dpi on a card with external dimensions of 86 mm×54 mm as a transfer body for retransfer, m is about 1000, and LNa is about 600, for example.

The transfer device 51 moves the ink ribbon 11 and the intermediate transfer film 21, which are in close contact with each other, while properly energizing each heating resistor 16a of the thermal head 16 based on the color transfer image data SN1A or SN1B at the transfer of the color inks, and based on the metal transfer image data SN2A or the watermark transfer image data SN2B at the transfer of the metal ink. The transfer device 51 thus transfers and superimposes the inks of the ink layers 11b of the ink ribbon 11 in the same frame F of the transfer image receiving layer 21c of the intermediate transfer film 21.

Accordingly, the transfer device 51 thereby transfers and forms a desired glossy color image in the frame F of the transfer image receiving layer 21c. The details of this image-forming operation are described later.

Returning to FIG. 1, the printer PR includes the retransfer device 52. The retransfer device 52 retransfers a part of the image (hereinafter, also referred to as intermediate image P) formed in the transfer image receiving layer 21c of the intermediate transfer film 21 as the transfer body in the transfer device 51, to one of the card materials 31a as another transfer body, producing each card 31.

The retransfer device 52 includes a retransfer unit ST1, a supply unit ST2, and a delivery unit ST3. The supply unit ST2 supplies the card materials 31a to the retransfer unit ST1. The delivery unit ST3 delivers the cards 31 having passed through the retransfer unit ST1.

The supply unit ST2 includes the reorientation unit ST2a, which rotates each card material 31a by 90 degrees. The supply unit ST2 raises the rightmost (shown in FIG. 1) of the plural card materials 31a, which are standing vertically, loaded in the stacker 32. The supply unit ST2 then supplies the card material 31 to the reorientation unit ST2a. The reorientation unit ST2a conveys and supplies the reoriented card material 31a to the retransfer unit ST1.

In the retransfer unit ST1, the card material 31a is pressed and sandwiched together with the intermediate transfer film 21 while moving toward the conveyance unit ST3. The card material 31a is brought into pressure contact with the transfer image receiving layer 21c of the intermediate transfer film 21.

Through the aforementioned movement of the card material 31a in pressure contact, a partial range of the intermediate image P formed in the transfer image receiving layer 21c by the transfer device 51 is transferred onto the card material 31a to form the image Pc. That is, the formed image Pc formed as a formed image is formed on the surface of the card material 31a by retransfer, thus producing the card 31.

The storage unit MR previously stores an operation program for controlling the entire operation of the printer PR including the transfer device 51, the transfer image information J3 as information of an image to be transferred and the like. The contents stored in the storage unit MR are referred to by the controller CT when needed.

The transfer image information J3 is supplied from the external data device 38 (refer to FIG. 2) and the like to the controller CT through the communication unit 37 as the input unit, and is stored in the storage unit MR.

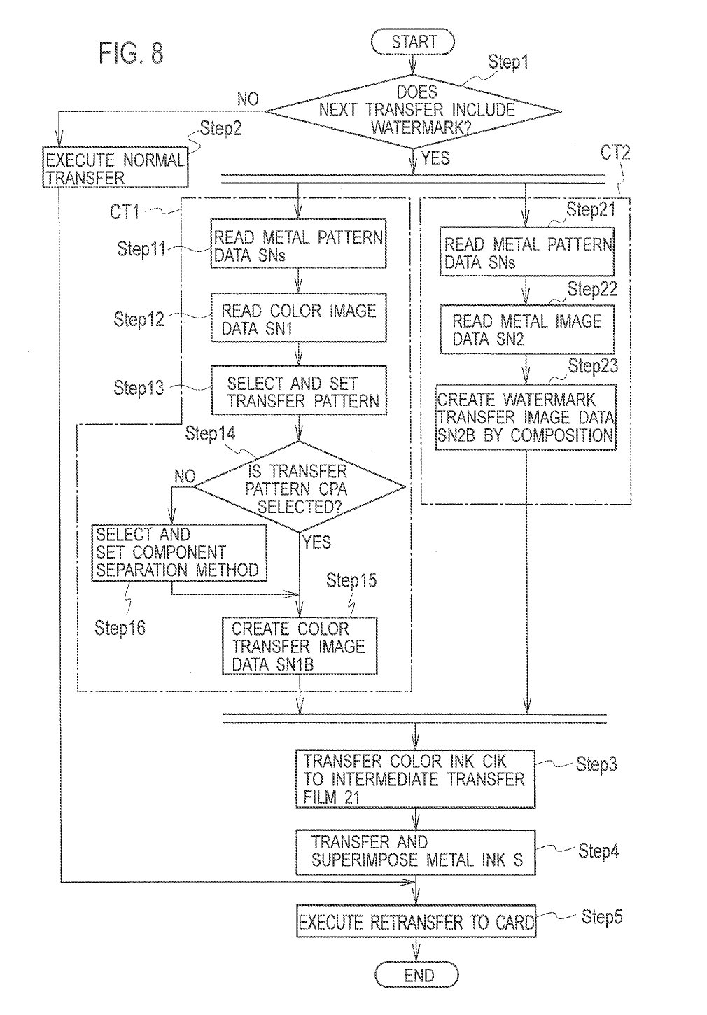

Next, the way of creating the color transfer image data SN1B and the watermark transfer image data SN2B in the process of transferring a watermarked image is described in detail with reference to FIGS. 8 to 24.

The printer PR is capable of selectively printing both watermarked color images and normal color images with no watermarks on the transfer body.

In the transfer operation, the controller CT determines whether the transfer to be executed next is a transfer including a watermark section or including no watermark section (FIG. 8: Step1).

The above determination is performed based on an external instruction through the communication unit 37. The determination may be performed based on the watermark image information J3a previously included in the transfer image information J3, instead of such an external instruction.

The watermark image information J3a represents whether the metal image data SN2 corresponds to a watermark image as indicated by a dotted dashed line in FIG. 7.

When the transfer to be executed next is not a transfer including a watermark section (No in Step1), the controller CT executes the normal transfer operation to transfer and form a color image with no watermark section (Step2). The color image data transmitter CT1 creates the color transfer image data SN1A, and the metal image data transmitter CT2 creates the metal transfer image data SN2A. Using the created data SN1A and SN2A, the controller CT executes the operations to transfer the color ink and the metal ink, respectively.

When the transfer to be executed next is a transfer including a watermark section (Yes), the controller CT executes a watermark transfer operation to transfer and form the formed image Pc as a watermarked color image. In the watermark transfer operation, processing of the color image data transmitter CT1 is executed parallel to processing of the metal image data transmitter CT2.

First, the processing of the metal image data transmitter CT2 is described. As illustrated in FIG. 8, the metal image data transmitter CT2 reads the metal pattern data SNs stored in the storage unit MR (Step21). The metal pattern data SNs is data specifying the basic transfer pattern PtS as a base of the image to be transferred with the metal ink in the watermark transfer operation.

FIG. 9 is a schematic diagram for explaining the basic transfer pattern PtS. The basic transfer pattern PtS is used to transfer the metal ink with a predetermined pattern with respect to the matrix M, which is associated with a region including the whole or a part of the formed image Pc. The matrix M is composed of the plural metal pixels Mg, having the minimum pixel size that allows transfer of the metal ink thereto.

FIG. 9 illustrates the matrix M, which is composed of 625 metal pixels Mg (25 rows×25 columns) as an example. In the example described herein, the size of the metal pixels Mg is the same as that of the pixels of the minimum unit that allows the sublimation color inks to be transferred thereto.

In the matrix M illustrated in FIG. 9, black pixels represent pixels to which the metal ink is to be transferred among the 625 metal pixels Mg. That is, the matrix M, illustrated in FIG. 9, is an example in which the metal ink is transferred in a checkerboard transfer pattern, which is the basic transfer pattern PtS.

When the metal ink is transferred according to the basic transfer pattern PtS, the area occupied by the metal ink per unit area is approximately half of that in the so-called solid transfer, in which metal ink is transferred to all of the metal pixels Mg in the matrix M. That is, in the case where the metal ink is transferred according to the basic transfer pattern PtS, the intensity of regularly reflected light across the entire region of the matrix M is approximately half of that in the case where the metal ink is transferred to all of the metal pixels Mg in the matrix M.

Hereinafter, in the process to transfer the metal ink according to the basic transfer pattern PtS, the pixels (black pixels in FIG. 9) among the metal pixels Mg to which the metal ink is to be transferred are referred to as metal transfer pixels Mgy, and the pixels (white pixels in FIG. 9) to which the metal ink is not to be transferred are referred to as metal non-transfer pixels Mgn.

That is, the basic transfer pattern PtS is set as a pattern to cause the metal transfer pixels Mgy and the metal non-transfer pixels Mgn to be dispersed and evenly mixed in a predetermined image region including the watermark transfer image Pt.

Returning to FIG. 8, the metal image data transmitter CT2 reads the metal image data SN2 stored in the storage unit MR (Step22). The order to execute Step21 and Step22 is not limited and may be reversed.

The metal image data SN2 is image data specifying a watermark section providing the watermark effect. FIG. 10 illustrates an example of the watermark section (hereinafter, referred to as the watermark transfer image Pt), which is transferred according to the metal image data SN2. In this example, the watermark transfer image Pt is an image in which the letter “N” is visually recognized by the watermark effect.

That is, the metal image data SN2 is data specifying the arrangement of the metal transfer pixels Mgy that allows N to be visually recognized. The metal image data SN2 also specifies the positions of the metal transfer pixels Mgy with respect to the matrix M.

The transfer region size and the numbers of the rows and columns of pixels of the metal pattern data SNs are usually set as equal to those of the metal pattern data SN2, like the matrix M, for example. It is therefore unnecessary to adjust the size of the region and the position of the region to which the watermark transfer image Pt is to be transferred.

The position or size of the watermark transfer image Pt can be changed by an external instruction or the like through the communication unit 37. The metal image data SN2 may be configured as data not including the transfer region size, so that the position and size of the watermark transfer image Pt is set by an external instruction.

Returning to FIG. 8, the metal image data transmitter CT2 composes the read metal pattern data SNs and the metal image data SN2 to create the watermark transfer image data SN2B (Step23). FIG. 11 illustrates a watermark transfer composite image PtG, transferred according to the watermark transfer image data SN2B.

Next, a description is given of the processing of the color image data transmitter CT1. In FIG. 8, the color image data transmitter CT1 reads the metal pattern data SNs from the storage unit MR similarly to the metal image data transmitter CT2 (Step11). The color image data transmitter CT1 reads the color image data SN1 stored in the storage unit MR (Step12). The order to execute Step11 and Step12 is not limited and may be reversed.

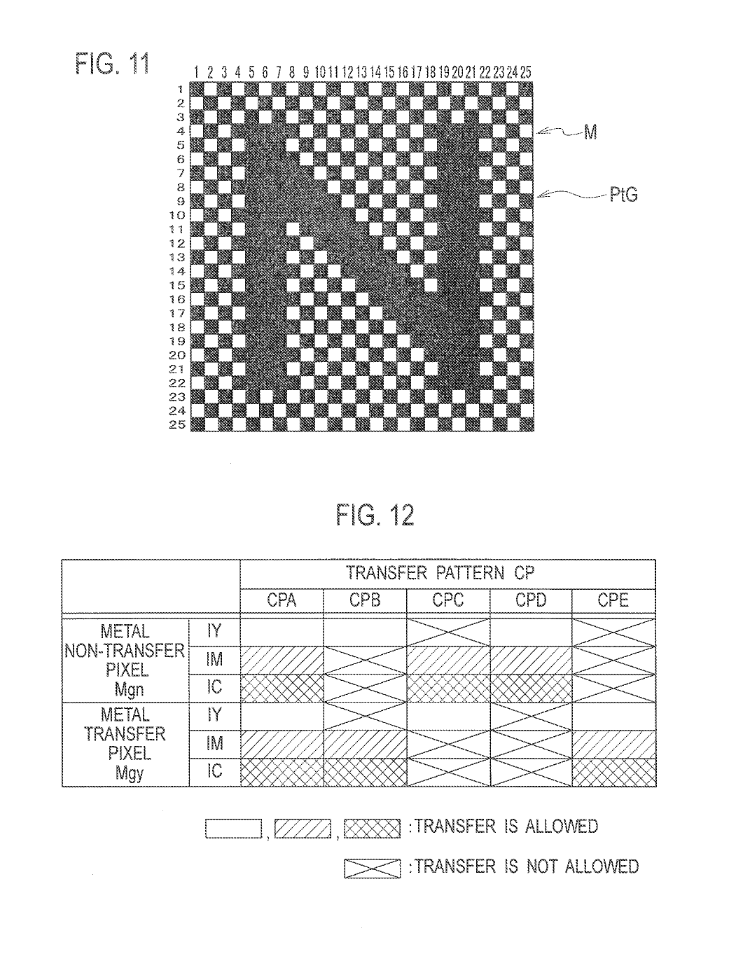

The color image data transmitter CT1 selects one of the plural types of previously set transfer patterns CP for color inks (Step13). The plural types of transfer patterns CP include the transfer patterns CPA to CPE in this example, which are illustrated in FIG. 12.

In the process of transferring and forming the color image Pd specified by the color image data SN1 with the yellow ink IY, magenta ink IM, and cyan ink IC, each transfer pattern CP is used to specify the positions to which each ink can be transferred (hereinafter referred to as color ink transfer positions) on a pixel basis. The transfer pattern CP specifies the association between each ink, the metal transfer pixels Mgy, and the metal non-transfer pixels Mgn.

FIG. 12 is a table illustrating the correspondence between the metal transfer pixels Mgy, the metal non-transfer pixels Mgn, and the inks IY, IM, and IC to be transferred to the pixels. As illustrated in FIG. 12, in the transfer patterns CPB to CPE, each of the yellow ink IY, magenta ink IM, and cyan ink IC is not allowed to be transferred to either the metal transfer pixels Mgy, or the metal non-transfer pixels Mgn.

In FIG. 12, the cells indicated by × correspond to pixels to which the corresponding ink cannot be transferred. The blank cells correspond to pixels to which the yellow ink IY can be transferred, the normal hatched cells correspond to pixels to which the magenta ink IM can be transferred, and the cross-hatched cells correspond to pixels to which the cyan ink IC can be transferred.

Each transfer pattern CP is described below. In the transfer pattern CPA, the yellow ink IY, magenta ink IM, and cyan ink IC can be transferred to both the metal non-transfer pixels Mgn and metal transfer pixels Mgy.

According to the transfer pattern CPB, the yellow ink IY is transferred to only the metal non-transfer pixels Mgn. The magenta ink IM and the cyan ink IC are transferred to only the metal transfer pixels Mgy.

According to the transfer pattern CPC, the yellow ink IY is transferred to only the metal transfer pixels Mgy. The magenta ink IM and the cyan ink IC are transferred to only the metal non-transfer pixels Mgn. The transfer pattern CPC is the inversion of the transfer pattern CPB.

According to the transfer pattern CPD, the yellow ink IY, the magenta ink IM, and the cyan ink IC are transferred to only the metal non-transfer pixels Mgn, and are not transferred to the metal transfer pixels Mgy.

According to the transfer pattern CPE, the yellow ink IY, magenta ink IM, and cyan ink IC are transferred to only the metal transfer pixels Mgy, and are not transferred to the metal non-transfer pixels Mgn. The transfer pattern CPE is the inversion of the transfer pattern CPD.

According to the transfer patterns CPB to CPE, as described above, each of the ink IY, ink IM, and ink IC can be transferred to either the metal non-transfer pixels Mgn or the metal transfer pixels Mgy, and are not transferred to the others. The color components corresponding to each metal pixel in which the color ink can be transferred are set based on a component separation method described below, for example.

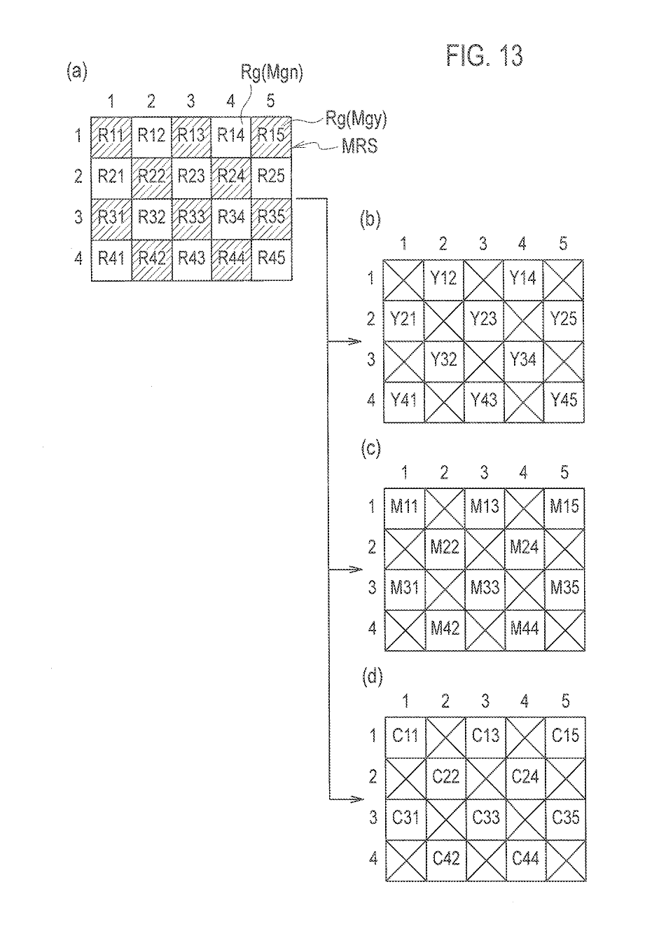

FIG. 13 is a diagram for explaining an example of a component separation method in the process of transferring the ink IY, IM, and IC according to the transfer pattern CPB, for example. In (a) of FIG. 13, the minimum pixels in which color ink can be transferred are referred to as color pixels Rg, and the transfer region is associated with a matrix MRS of the plural color pixels Rg. In this example, the matrix MRS is composed of 20 color pixels Rg (four rows by five columns). The matrix MRS also corresponds to the first to fourth rows by the first to fifth columns in the matrix M.

In the matrix MRS of (a) of FIG. 13, the hatched color pixels Rg correspond to the metal transfer pixels Mgy, and the non-hatched (blank) color pixels Rg correspond to the metal non-transfer pixels Mgn.

Each color pixel Rg is specified by reference numeral R (row and column). For example, the color pixel Rg in the second row of the third column is referred to as color pixel R23. Each color pixel Rg is associated with color component information consisting of yellow, magenta, and cyan. The color pixel R23 is associated with information of the yellow component Y23, the magenta component M23, and the cyan component C23.

(b), (c), and (d) of FIG. 13 illustrate transfer patterns of the yellow ink IY, magenta ink IM, and cyan ink IC according to the transfer pattern CPB, respectively. The pixels with × are pixels to which each ink cannot be transferred according to the transfer pattern CPB.

That is, the yellow ink IY can be transferred to only the color pixels Rg corresponding to the metal non-transfer pixels Mgn, as illustrated in (b) of FIG. 13. The magenta ink IM and cyan ink IC can be transferred to only the metal transfer pixels Mgy, as illustrated in (c) and (d) of FIG. 13.

When the transfer pattern set in Step13 is any one of the transfer patterns CPB to CPE other than the transfer pattern CPA (NO in Step14), the component separation method to execute the transfer of the inks IY, IM, and IC, as illustrated in (b) to (d) of FIG. 13, is selected and set (Step16). In this example, the component separation method is selected from a thinning separation method or an average separation method, as described below.

### <Thinning Separation Method>

When transferring the magenta ink IM and the cyan ink IC, the magenta component and cyan component of each color pixel Rg are directly applied. For example, the magenta and cyan components of the color pixel R11 are applied to M11 and C11, respectively. The magenta and cyan components of the color pixel R22 are applied to M22 and C22, respectively.

When transferring the yellow ink IY, the yellow component of the color pixel Rg, which is next to the color pixel Rg in the same row and has a larger column number, is applied when the pixel in the first column of the row including the color pixel Rg is the pixel that can be transferred. This applies to the even-numbered rows in (b) of FIG. 13.

The yellow component of the color pixel Rg, which is next to the color pixel Rg in the same row and has a smaller column number, is applied, when the pixel in the first column of the row including the color pixel Rg is the pixel that cannot be transferred. This applies to the odd-numbered rows in (b) of FIG. 13.

For example, the yellow components of the color pixels R11 and R13 are applied to Y12 and Y14, respectively. The yellow components of color pixels R22 and R24 are applied to Y21 and Y23, respectively.

### <Average Separation Method>

When transferring the yellow ink IY, the average value of the yellow component of the color pixel Rg and the yellow component of the adjacent color pixel Rg in the same row, is applied.

When the pixel in the first columns of the row including the color pixel Rg is the pixel that can be transferred (in an even-numbered row in (a) of FIG. 13), the adjacent color pixel is a color pixel Rg which is next to the color pixel Rg in the same row and has a larger column number.

When the pixel in the first column of the row including the color pixel Rg is a pixel that cannot be transferred (in an odd-numbered row in (a) of FIG. 13), the adjacent color pixel is a color pixel Rg which is next to the color pixel Rg in the same row, and has a smaller column number.

When transferring the magenta ink IM, the average of the magenta component of the color pixel Rg and the magenta component of the adjacent color pixel Rg in the same row, is applied.

When transferring the cyan ink IC, the average of the cyan component of the color pixel Rg and the cyan component of the adjacent color pixel Rg in the same row, is applied.

When the pixel in the first column of the row including the color pixel Rg is a pixel that can be transferred (in odd-numbered columns in (c) and (d) of FIG. 13), the adjacent color pixel is a color pixel Rg, which is next to the color pixel Rg in the same row and has a larger column number.

When the pixel in the first column in the row including the color image Rg is a pixel that cannot be transferred (in even-numbered columns in (c) and (d) of FIG. 13), the adjacent color pixel is the color pixel Rg, which is next to the color pixel Rg in the same row and has a smaller column number.

Returning to FIG. 8, the color image data transmitter CT1 selects and sets one of the five types of transfer patterns CPA to CPE, for example, of color inks in Step13.

When having selected the transfer pattern CPA (YES in Step14), the color image data transmitter CT1 creates the color transfer image data SN1B directly using the yellow, magenta, and cyan components corresponding to each color pixel Rg in the color image data SN1 (Step15).

When having selected one of the transfer patterns CPB to CPE other than the transfer pattern CPA (NO in Step14) as described above, the component separation method is set to any one of the thinning separation method or the average separation method, for example (Step16).

The color image data transmitter CT1 applies the selected transfer pattern CP and component separation method to the color image data SN1 to create the color transfer image data SN1B (Step15).

The color transfer image data SN1B is data including the image data SN1By of an image to be transferred with the yellow ink IY of the ink layer 11Y, the image data SN1Bm of an image to be transferred with the magenta ink IM of the ink layer 11M, and the image data SN1Bc of an image to be transferred with the cyan ink IC of the ink layer 11C.

The color image data transmitter CT1 performs the selection and determination of the transfer pattern CP and the component separation method in Step13 and Step15, based on an external instruction through the communication unit 37. Moreover, the color image data transmitter CT1 performs the selection and determination of the transfer pattern CP and component separation method, based on the selection determination information J3b instead of the external instruction. The selection determination information J3b is included in the transfer image information J3 in advance.

The selection determination information J3b is information that specifies the transfer pattern CP and the component separation method, which are to be applied to creating the color transfer image data SN1B from the color image data SN1 when the metal image data SN2 corresponds to a watermark image, as illustrated in the dotted dashed line in FIG. 7.

Returning to FIG. 8, when the color transfer image data SN1B and watermark transfer image data SN2B are created in Step15 and Step23, the controller CT first transfers color ink to the intermediate transfer film 21 according to the color transfer image data SN1B, to form the color image Pd (Step3).

Next, the controller CT transfers and superimposes the metal ink on the color image Pd according to the watermark transfer image data SN2B, to form the intermediate image P (Step 4).

The intermediate image P, formed through the normal transfer in Step2 or the watermark transfer in Step3 and Step4, is transferred again to the card material 31a (Step5), thereby forming a glossy formed image Pc through Step2, or forming a watermarked formed image Pct through Step4.

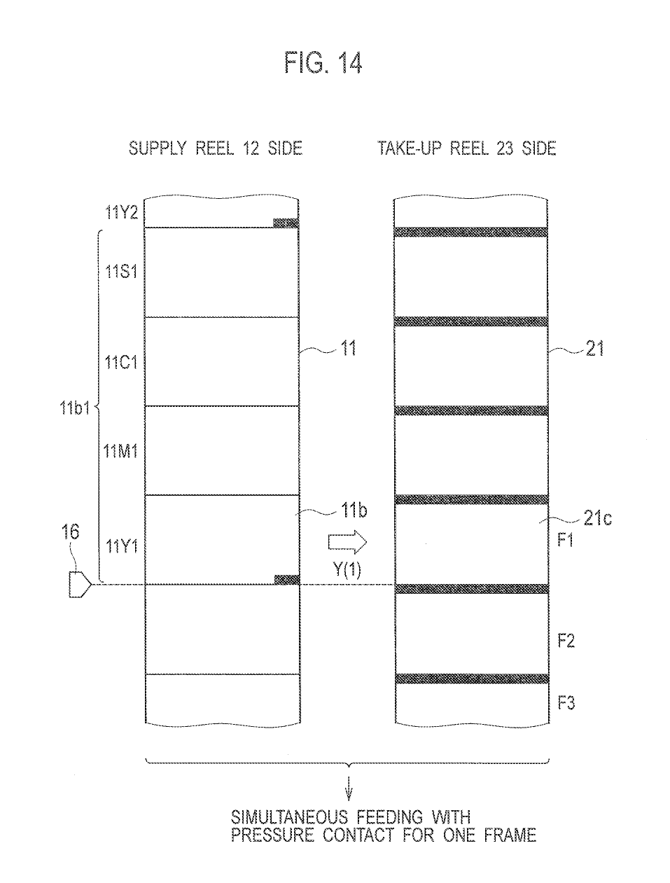

Next, with reference to FIGS. 14 to 24, a description is given of the specific operation and method to form an image on the intermediate transfer film 21, which are executed by the transfer device 51, using the color transfer image data SN1B and the watermark transfer image data SN2B, that is, the operation and method in Step3 and Step4 in FIG. 8.

The transfer device 51 performs a rewinding operation and a cueing operation in each operation to transfer the three types of color ink and the metal ink. The operation procedure described below is the procedure of transferring the intermediate image P to the frame F1 of the intermediate transfer film 21.

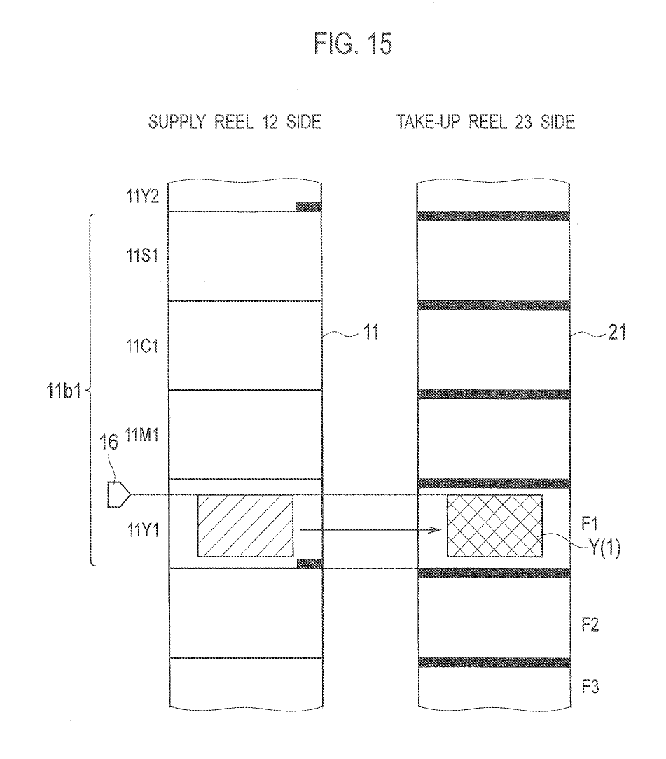

FIGS. 14 and 15 illustrate the thermal head 16 which is not movable in the conveyance direction (the longitudinal direction) of the ink ribbon 11, the positions of the ink ribbon 11 and intermediate transfer film 21 relative to the position of the thermal head 16, and the transferred contents.

The surface of the ink layer 11b of the ink ribbon 11 and the surface of the transfer image receiving layer 21c of the intermediate transfer film 21, which are in close contact during the transfer operation, are illustrated side by side.

First, as illustrated in FIG. 14, the transfer device 51 performs the cueing operation to align the yellow ink layer 11Y1 with the frame F1.

Next, the transfer device 51 shifts the thermal head 16 to the pressure contact position, and moves the ink ribbon 11 and intermediate transfer film 21 downward (in FIG. 14) together and into contact with each other. The yellow ink IY of the ink layer 11Y1 is therefore transferred to the frame F1 according to the image data SN1By, to form the image Y(1).

The aforementioned close contact movement is performed by one frame. The feeding direction of the ink ribbon 11 is the winding direction (forward-feeding), and the feeding direction of the intermediate transfer film 21 is the rewinding direction (backward-feeding).

The formed image Y(1) is an image which is obtained by transferring the yellow ink 1Y in a checkerboard pattern corresponding to (b) of FIG. 13, when the selected transfer pattern CP is the transfer pattern CPB, for example.

FIG. 15 illustrates the state where the transfer of the image Y(1) to the intermediate transfer film 21 is finished. In the frame F1 of the intermediate transfer film 21, the image Y(1) of the yellow ink is transferred and formed.

As illustrated in FIG. 15, in the frame F1 to which the image Y(1) is transferred with the yellow ink IY of the ink layer 11Y1, the magenta ink IM of the ink layer 11M1 is to be transferred and superimposed according to the image data SN1Bm as an image M(1). The image M(1), to be transferred and superimposed, is an image corresponding to (c) of FIG. 13.

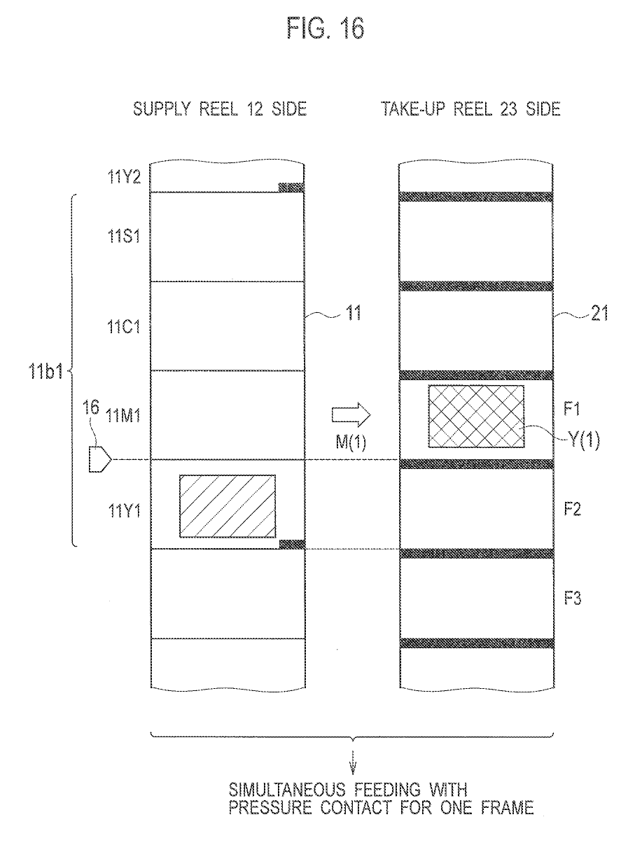

In the superimposition and transfer of the image M(1) as illustrated in FIG. 16, the transfer device 51 performs the cueing operation to align the magenta ink layer 11M1 with the frame F1.

Subsequently, the transfer device 51 shifts the thermal head 16 to the pressure contact position, and moves the ink ribbon 11 and intermediate transfer film 21 downward (in FIG. 16), which are in close contact with each other. The magenta ink IM of the ink layer 11M1 is therefore transferred and superimposed on the frame F1 according to the image data SN1Bm, to form the image M(1).

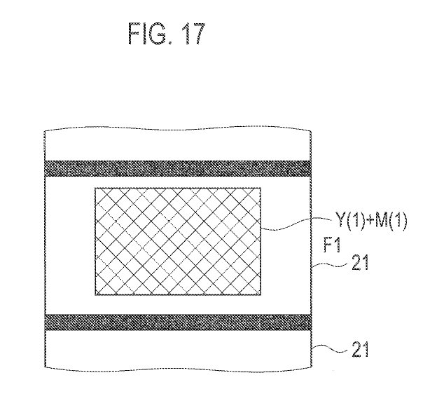

In the frame F1, an image composed of the image Y(1) and the image M(1) superimposed on each other is formed, as illustrated in FIG. 17.

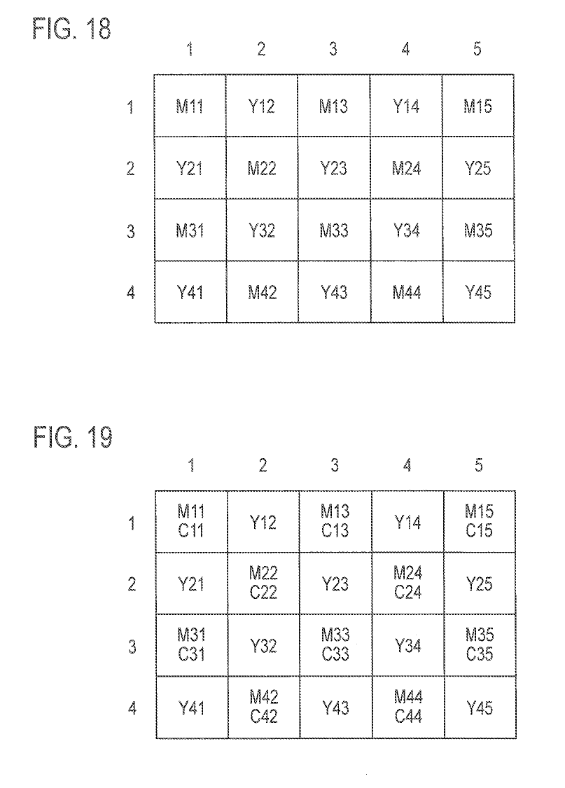

According to the transfer pattern CPB, the magenta ink IM is transferred to pixels where the yellow ink IY is not transferred in the image Y(1). When the magenta ink IM is transferred and superimposed according to the transfer pattern CPB, the transferred ink in each pixel is as illustrated in FIG. 18.

In a similar manner, the transfer device 51 therefore transfers and superimposes the cyan ink IC of the ink layer 11C1 on the frame F1 according to the image data SN1Bc, to form the image C(1). In the frame F1, therefore, an image composed of the images Y(1), M(1), and C(1) superimposed on each other is formed.

When the cyan ink IC is transferred and superimposed according to the transfer pattern CPB, the transferred ink in each pixel is as illustrated in FIG. 19.

In a similar manner, the transfer device 51 transfers and superimposes the metal ink of the ink layer 11S1 on the frame F1 according to the watermark transfer image data SN2B generated by the metal image data transmitter CT2, to form the image S(1) as the watermark transfer composite image PtG.

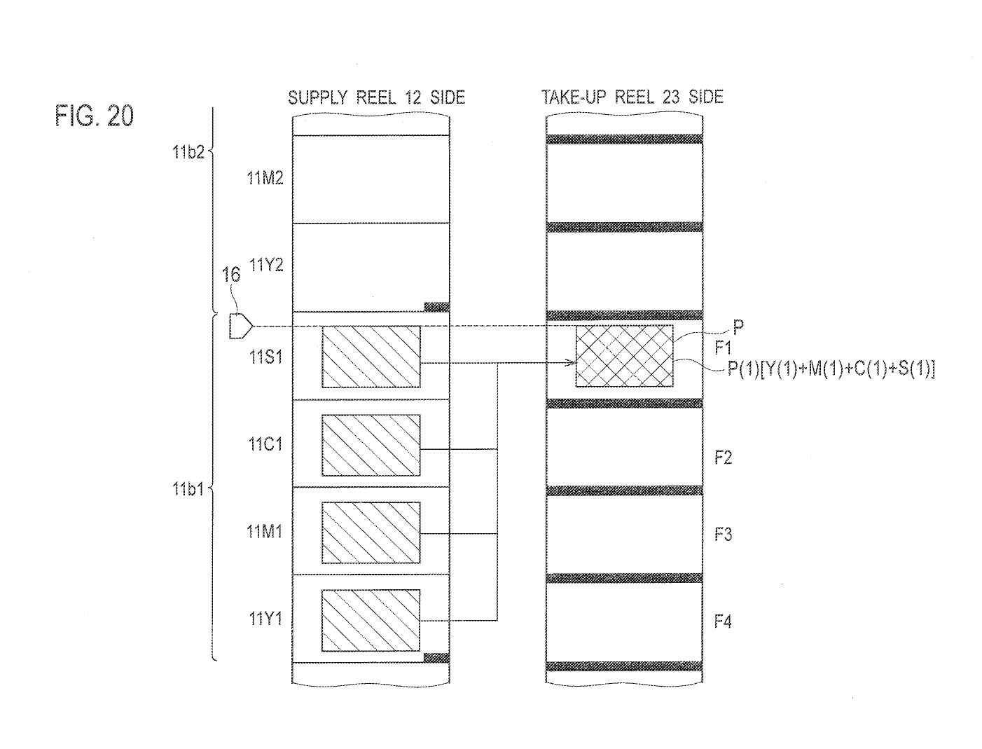

FIG. 20 illustrates the state where transfer of the image S(1) of the metal ink as the fourth color is finished. In the frame F1, the images Y(1), M(1), C(1), and S(1) are transferred and superimposed to form the image P(1) as the intermediate image P. Hereinafter, the minimum pixels constituting the intermediate image P are referred to as the intermediate image pixels Pg.

When the metal ink is transferred and superimposed according to the transfer pattern CPB, the transferred ink in each pixel in a part other than the watermark transfer image Pt is as illustrated in FIG. 21. In FIG. 21, the intermediate image pixels Pg, to which the metal ink is transferred, are indicated by hatching.

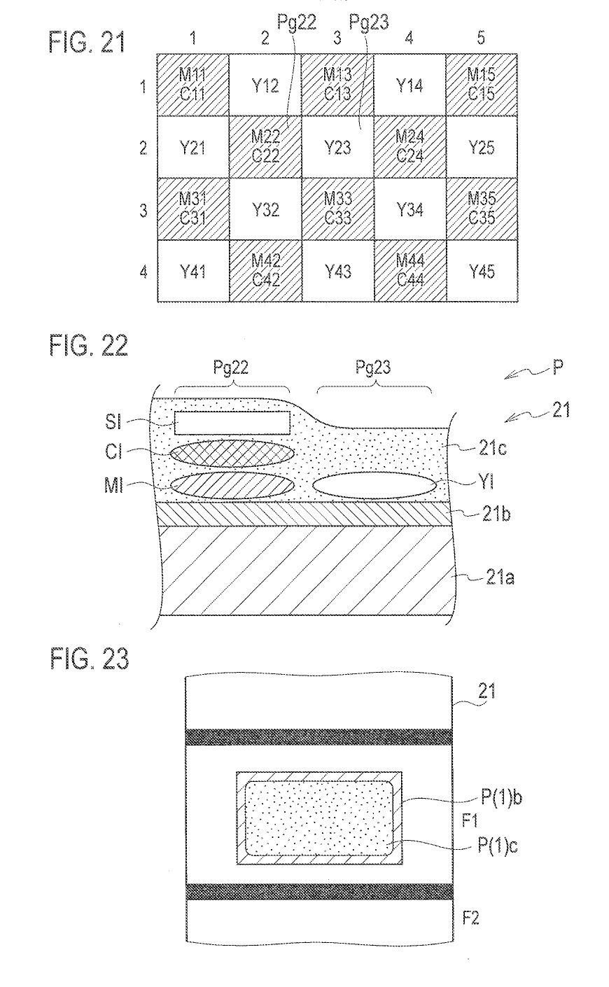

The schematic cross-sectional view of the intermediate transfer film 21 in this state is illustrated in FIG. 22. To be specific, FIG. 22 is a schematic cross-sectional view of the intermediate image pixels Pg corresponding to the pixels Pg 22 and 23 of FIG. 21 in the intermediate image P, formed in the intermediate transfer film 21.

The transfer image receiving layer 21c includes dye YI (a white ellipse) of the yellow ink sublimated and transferred, dye MI (normal hatching) of the magenta ink, dye CI (cross hatching) of the cyan ink, and pigment SI (a rectangle) of the metal ink. The pigment SI of the metal ink is transferred at the end and is therefore received in the far side from the film base 21a in the transfer image receiving layer 21c.

The image P(1) is an image formed by the transfer of the metal ink based on the watermark transfer image data SN2B. In the part not corresponding to the watermark transfer image Pt, no metal ink is transferred in the pixel (pixel Pg23) adjacent to the pixel (pixel Pg22), with the metal ink transferred according to the basic transfer pattern PtS.

In the pixel (pixel Pg22) with the metal ink transferred, the magenta ink IM and the cyan ink IC can be transferred. In the pixel (pixel Pg23) with no metal ink transferred, the yellow ink IY can be transferred.

On the other hand, in the part corresponding to the watermark transfer image Pt, the metal ink is also transferred and superimposed in the pixels with the yellow ink IY transferred.

In the frames subsequent to the frame F1, the image P(2) and subsequent images can be formed in the same way as the image P(1) is formed in the frame F1. Apart of the intermediate image P formed in each frame F is retransferred to the corresponding one of the card materials 31a as the watermarked formed image Pct by the retransfer device 52.

FIG. 23 illustrates the state of the intermediate transfer film 21 after the image P(1) formed in the frame F1 (illustrated in FIG. 20) is retransferred to the card material 31a. To be specific, a part of the image P(1) is transferred to the card material 31a, so that a retransfer range P(1)c (dotted part) is formed.

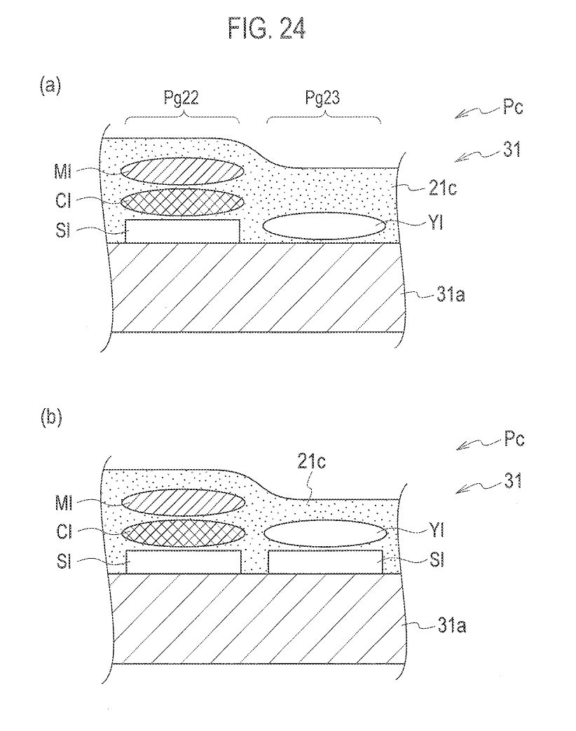

FIG. 24 illustrates partial cross-sectional views of the card 31 with the image Pc retransferred thereto. (a) of FIG. 24 illustrates the state of a part of the card 31 not corresponding to the watermark transfer image Pt (illustrated in FIG. 22) after retransfer. (b) of FIG. 24 illustrates an example of the part corresponding to the watermark transfer image Pt.

As illustrated in (a) and (b) of FIG. 24, on the surface of the card material 31a (a card 31 with no image transferred thereon), the transfer image receiving layer 21c is transferred. After transfer from the intermediate transfer film 21, the surface of the transfer image receiving layer 21c opposite to the ribbon base 11a is located on the card material 31a side. The metal ink (the pigment SI) is therefore located on the card material 31a side.

In the part (the pixel Pg22) of the formed image Pc formed on the card material 31a, where the metal ink is transferred, by applying the transfer pattern CPB, the dye CI of the cyan ink IC and the dye MI of the magenta ink IM are placed above the pigment SI of the metal ink.

In the part (the pixel Pg23) with no metal ink transferred, the dye YI of the yellow ink IY is received.

As for the pixels corresponding to the watermark transfer image Pt as illustrated in (b) of FIG. 24, the dye YI of the yellow ink IY is placed above the pigment SI of the metal ink.

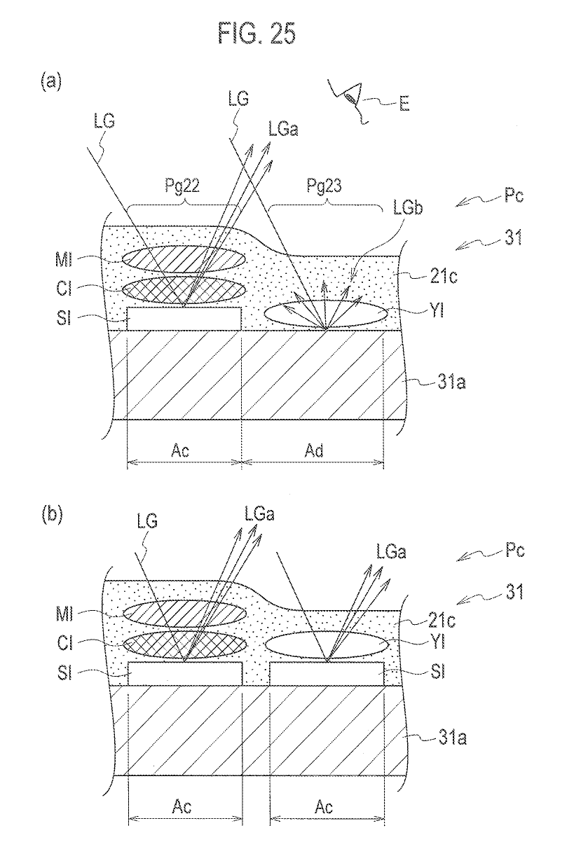

(a) and (b) of FIG. 25 are schematic diagrams illustrating the card 31 (the cross-sectional view thereof is illustrated in (a) and (b) of FIG. 24) irradiated with light LG in one direction.

In (a) of FIG. 25, a metal ink transferred section Ac (a section corresponding to a pixel illustrated by hatching in FIG. 21 and represented by the pixel Pg22) with the metal ink transferred thereto (substantially) regularly reflects the light LG with a high directivity, and emits the same as reflected light LGa. Since the magenta ink IM and cyan ink IC transmit light, the reflected light LGa is recognized as a glossy color, reflecting the colors of the magenta ink IM and the cyan ink IC, which are laid above the metal ink.

In the metal ink non-transferred section Ad (a section corresponding to a pixel illustrated with no hatching in FIG. 21 and represented by the pixel Pg23) with no metal ink transferred thereto, when the light LG is incident on the surface of the card material 31a, the light LG reaches the surface of the card material 31a since the yellow ink IY transmits light. The metal ink non-transferred section Ad diffusely reflects light, as indicated by the diffusely reflected light LGb, since the surface of the card material 31a has a surface roughness typical as a resin plate.

When an observer's eye E is located in the outgoing direction of the reflected light LGa, the metal ink transferred section Ac is visually recognized as a glossy metallic color region much brighter than the metal ink non-transferred section Ad.

On the other hand, when the observer's eye E is not located in the outgoing direction of the reflected light LGa, the eye E receives the diffusely reflected light LGb from the metal ink non-transferred section Ad much more than the reflected light LGa from the metal ink transferred section Ac. The metal ink transferred section Ac is visually recognized as a relatively dark region.

In (b) of FIG. 25 corresponding to the part of the watermark transfer image Pt, the adjacent pixels are the metal ink transfer sections Ac with the metal ink transferred. When the viewing direction of the observer's eye E is substantially equal to the outgoing direction of the reflected light, the watermark transfer image Pt can be visually recognized as a strongly glossy image.

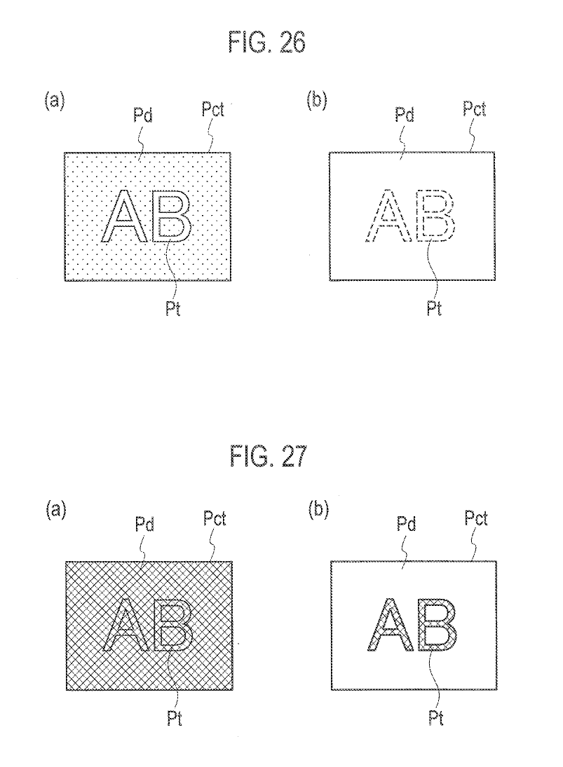

The way that the watermark transfer image Pt looks when the watermark transfer image Pt is seen in the direction that the watermark transfer image Pt can be visually recognized as a glossy image varies depending on the lightness (density) of the color image Pd as a background image of the watermark transfer image Pt, as illustrated in FIG. 26.

To be specific, in the watermarked formed image Pct, when the color image Pd is a dark image having a low lightness (a high density) as illustrated in (a) of FIG. 26, the watermark transfer image Pt can be visually recognized as a brighter region relative to the color image Pd depending on the viewing direction than when the color image Pd is a bright image having a high lightness (a low density) as illustrated in (b) of FIG. 26.

Hereinafter, the state where the watermark transfer image Pt looks bright relative to the environment as illustrated in (a) of FIG. 26 is referred to as a positive gloss state.

As illustrated in FIG. 27, the way that the watermark transfer image Pt looks when seen in the direction that the watermark transfer image Pt is difficult to visually recognize as a glossy image also varies depending on the lightness (density) of the color image Pd as the background image of the watermark transfer image Pt.

To be specific, in the watermarked formed image Pct, when the color image Pd is a bright part having a high lightness (a low density) as illustrated in (b) of FIG. 27, the watermark transfer image Pt can be visually recognized as a dark region relative to the environment more clearly than that when the color image Pd is a dark part having a low lightness (a high density) as illustrated in (a) of FIG. 27.

Hereinafter, the state where the watermark transfer image Pt looks dark relative to the environment, as illustrated in (b) of FIG. 27, is referred to as a negative gloss state.

Next, a description is given of the difference in appearance of the watermark transfer image Pt, between when the watermarked formed image Pct is formed by transferring only the watermark transfer image Pt with the metal ink without using the basic transfer pattern PtS and when the watermarked formed image Pct is formed by transferring with the metal ink, the watermark transfer composite image PtG composed of the basic transfer pattern PtS and the watermark transfer image Pt.

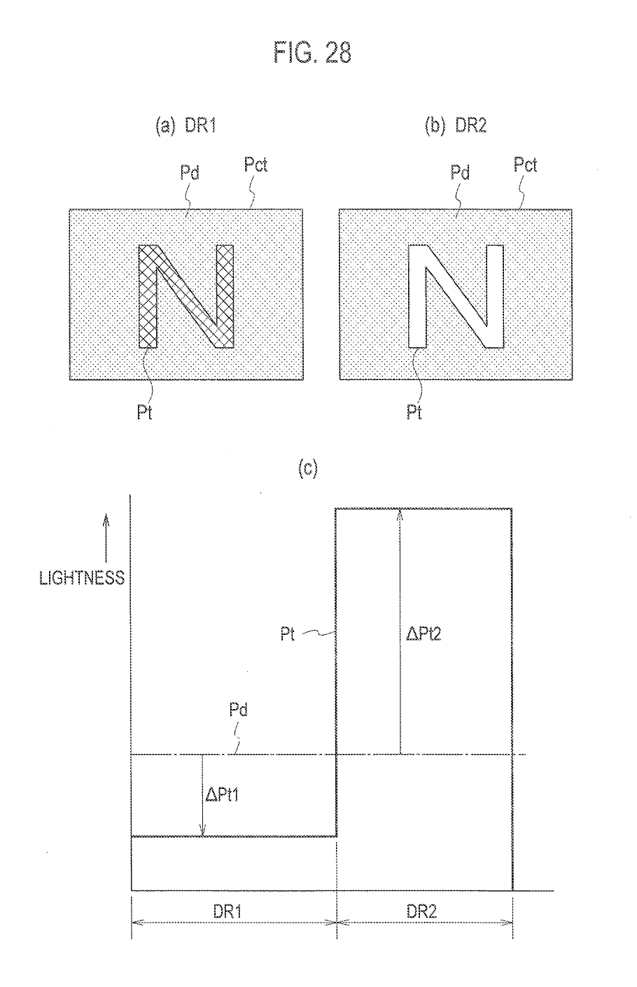

The following description refers to FIG. 25 and the conceptual diagrams in FIGS. 28 to 33. In the description, the watermarked formed image Pct formed on the card material 31a includes a character “N” as the watermark transfer image Pt and the non-glossy color image Pd as the background image of the character “N” in a predetermined range including the character “N”.

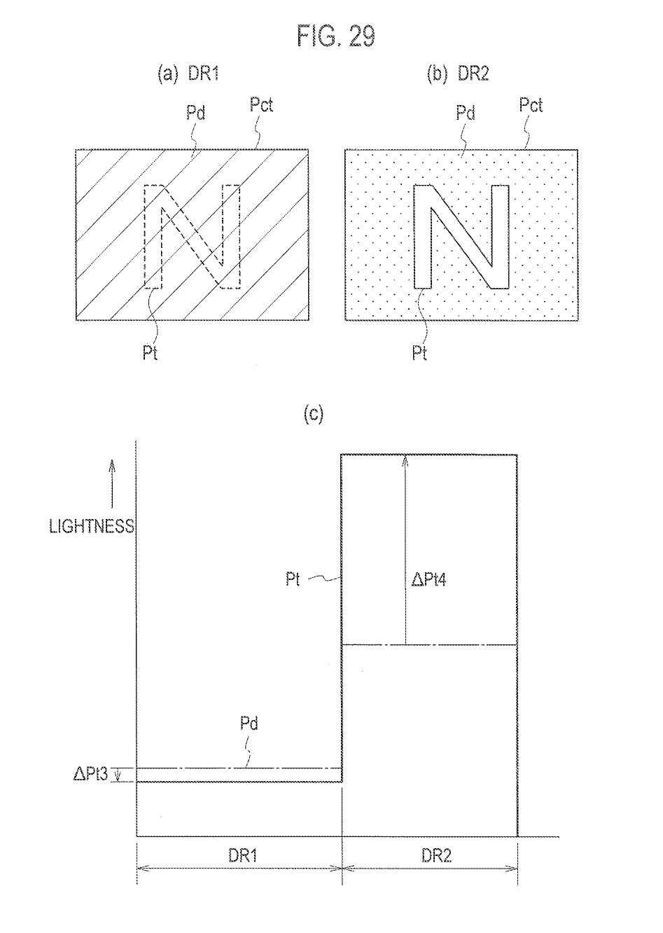

FIGS. 28 and 29 illustrate cases where the color image Pd has a high enough lightness (a low density). FIG. 28 illustrates a case of not using the basic transfer pattern PtS, and FIG. 29 illustrates a case of using the basic transfer pattern PtS.

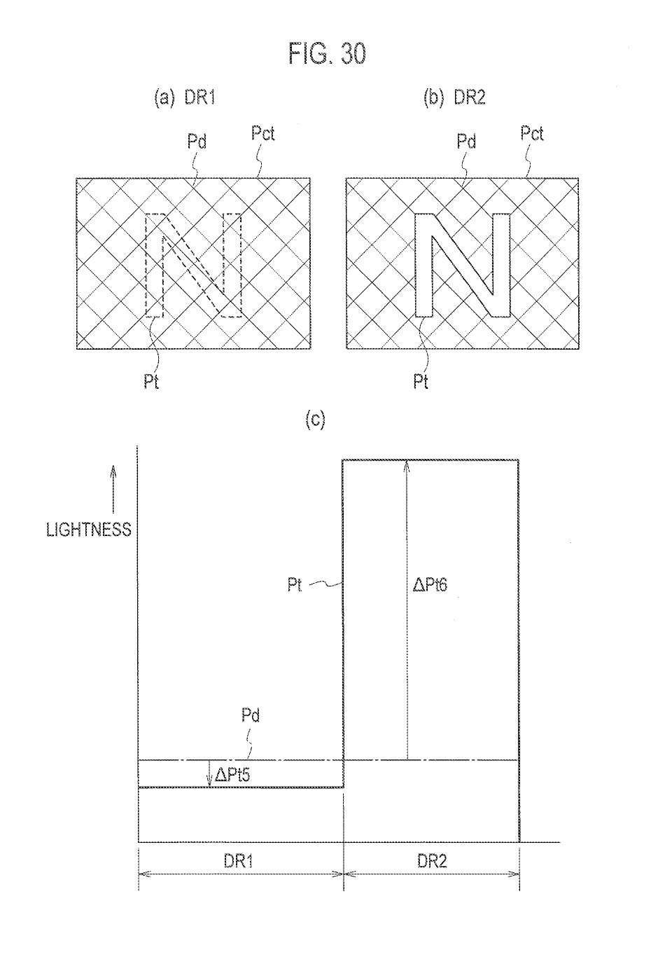

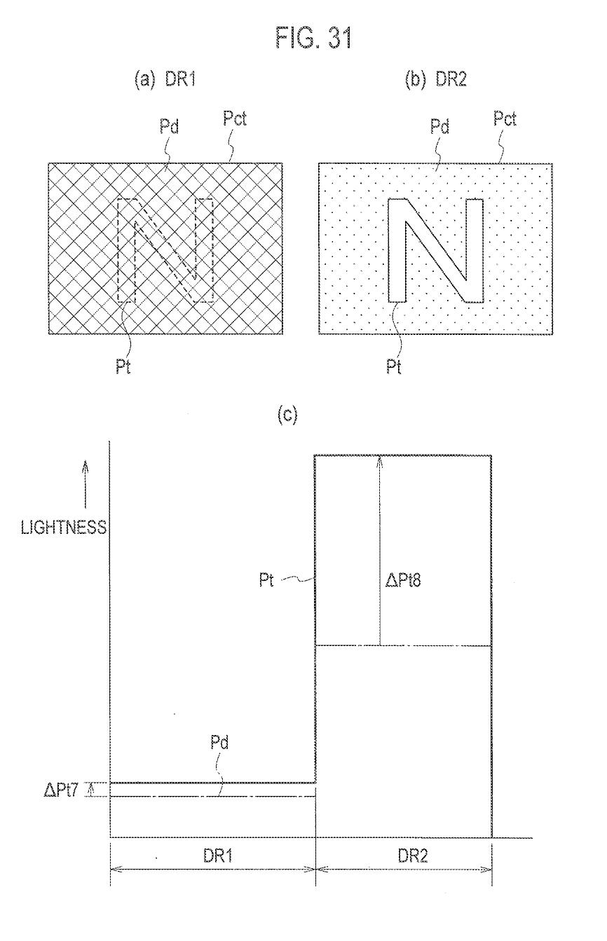

FIGS. 30 and 31 illustrate the cases where the color image Pd has a low enough lightness (a high density). FIG. 30 illustrates a case of not using the basic transfer pattern PtS, and FIG. 31 illustrates a case of using the basic transfer pattern PtS.

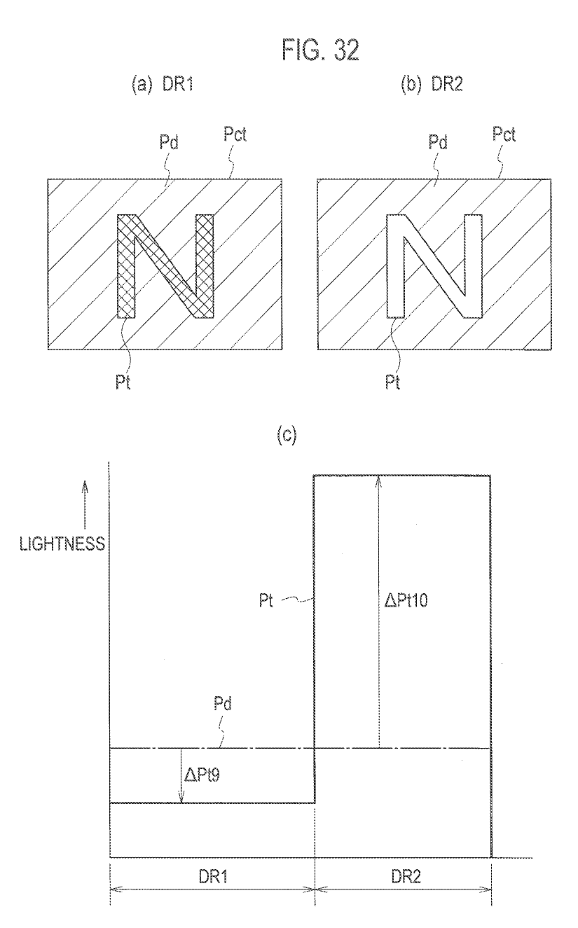

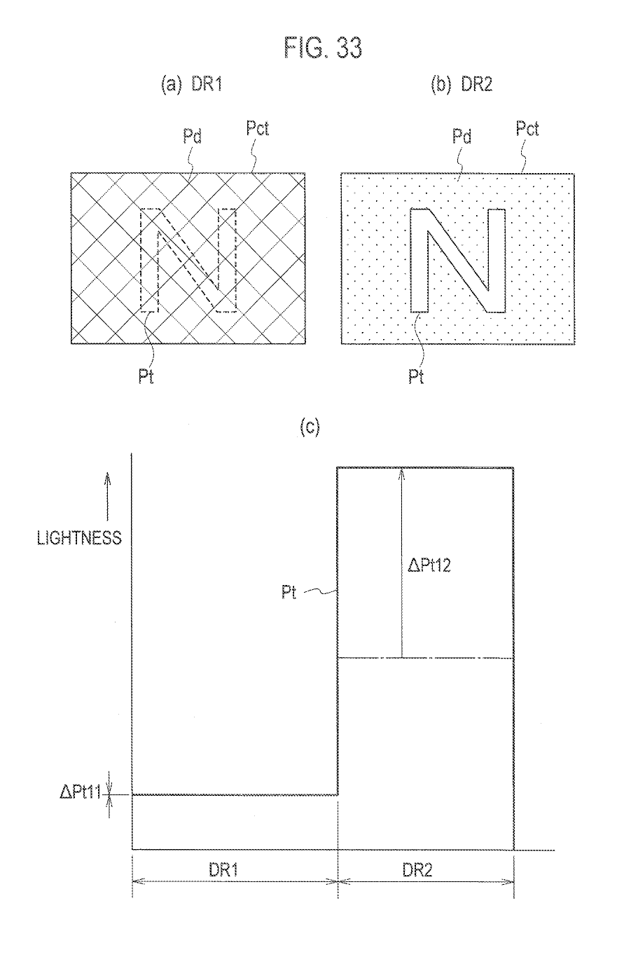

FIGS. 32 and 33 illustrate the cases where the color image Pd has a medium lightness (a medium density), at a lightness between the above two cases. FIG. 32 illustrates a case of not using the basic transfer pattern PtS, and FIG. 33 illustrates a case of using the basic transfer pattern PtS.

A description is given of a case where the color image Pd has a high lightness (a low density) as illustrated in FIGS. 28 and 29. In (a) of FIG. 28 and (a) of FIG. 29, the viewing direction is different from the direction of reflection from the watermark transfer image Pt (hereinafter, referred to as direction DR1). In (b) of FIG. 28 and (b) of FIG. 29, the viewing direction is approximately equal to the direction of reflection from the watermark transfer image Pt (hereinafter, referred to as direction DR2).

(c) of FIG. 28 and (c) of FIG. 29 are graphs illustrating the lightness of the color image Pd and the watermark transfer image Pt (hereinafter, referred to as visual lightness), which are visually recognized in the directions DR1 and DR2.

Independently of the lightness, in the case of not using the basic transfer pattern PtS, the color image Pd is represented with only color ink, and behaves like the metal ink non-transferred part Ad in (a) of FIG. 25. That is, the color image Pd is visually recognized by the diffusely reflected light LGb. The visual lightness of the color image Pd is therefore approximately constant independently of the visual direction.

On the other hand, the watermark transfer image Pt (approximately) regularly reflects light, and the visual lightness changes greatly depending on the viewing direction.

In the case of using the basic transfer pattern PtS, the color image Pd is represented by both the color ink and the metal ink. The basic transfer pattern PtS of the metal ink is a checkerboard pattern. Half of the area of the basic transfer pattern PtS behaves in the same manner as the metal ink transferred section Ac, while the other half behaves in the same manner as the metal ink non-transferred section Ad. That is, the area visually recognized through the diffusely reflected light LGb in the color image Pd is therefore half of that in the case of not using the basic transfer pattern PtS. The visual lightness of the color image Pd therefore depends on the visual direction.

The difference in appearance of the watermark transfer image Pt, with respect to the lightness, is described based on the aforementioned behavior. First, the description is given of a case where the color image Pd has a high lightness (a low density) (refer to FIGS. 28 and 29).

When the lightness is high enough and the basic transfer pattern PtS is not used as illustrated in FIG. 28, the visual lightness of the watermark transfer image Pt is significantly lower than that of the color image Pd in the direction DR1. The watermark transfer image Pt is visually recognized as the negative gloss state by the difference ΔPt1 therebetween.

The visual lightness of the watermark transfer image Pt in the direction DR2 is significantly increased, because the entire surface thereof specularly reflects light. The color image Pt has a significantly higher visual lightness than that of the color image Pd, and is visually recognized as the positive gloss state by the difference ΔPt2.

On the other hand, when the lightness is high and the basic transfer pattern PtS is used as illustrated in FIG. 29, the visual lightness of the color image data Pd in the direction DR1 is reduced to a value slightly higher than that of the watermark transfer image Pt, since the region that produces the reflected light LGb is halved.

The difference ΔPt3 in visual lightness between the color image Pd and the watermark transfer image Pt is produced, but is very small. The watermark transfer image Pt is not visually recognized substantially.

The visual lightness of the color image Pd in the direction DR2 is increased since half of the color image Pd produces the reflected light LGa. However, even in the presence of the diffusely reflected light LGb, the visual lightness of the color image Pd is just a little higher than half of the visual lightness of the watermark transfer image Pt, the entire region of which produces the reflected light LGa. Accordingly, the difference ΔPt4 is large, and the watermark transfer image Pt is visually well-recognized.

As described above, when the color image Pd has a high lightness and the basic transfer pattern PtS is not used, the watermark transfer image Pt can be visually recognized independently of the viewing direction, providing no watermark effect.

On the other hand, applying the basic transfer pattern PtS produces two states where the watermark transfer image Pt is visible or invisible, depending on the viewing direction, thus providing a good watermark effect. Moreover, the state that the watermark transfer image Pt is visible is the positive gloss state, with a large difference in visual lightness between the watermark transfer image Pt and the color image Pd as the background. The watermark effect therefore is of a high quality.

Next, a description is given of a case where the color image Pd has a low lightness (a high density), with reference to FIGS. 30 and 31.

When the lightness is low and the basic transfer pattern PtS is not used as illustrated in FIG. 30, the color image Pd is represented with only the color ink, and behaves in the same manner as the metal ink non-transferred section Ad in (a) of FIG. 25. That is, the color image Pd is visually recognized through the diffusely reflected light LGb. The visual lightness of the color image Pd is therefore low, and substantially constant independently of the viewing direction.

On the other hand, the watermark transfer image Pt greatly changes in visual lightness depending on the viewing direction. In the direction DR1, the watermark transfer image Pt has a visual lightness equal to that of the color image Pd, and is in the negative gloss state by the difference ΔPt5. However, the difference ΔPt5 is small, and the watermark transfer image Pt is not visually recognized substantially.

In the direction DR2, the visual lightness of the watermark transfer image Pt is significantly increased, since the entire surface thereof regularly reflects light. The watermark transfer image Pt has a significantly higher visual lightness than that of the color image Pd, and is visually recognized as the positive gloss state by the difference ΔPt6.

On the other hand, when the lightness is low and the basic transfer pattern PtS is used as illustrated in FIG. 31, the visual lightness of the color image Pd changes depending on the viewing direction in the same manner as the case where the color image Pd has a high lightness.

In the direction DR1, the visual lightness of the color image Pd, which originally has a sufficiently low lightness, is slightly lower than that of the watermark transfer image Pt. The difference ΔPt7 therebetween is very small, and the watermark transfer image Pt is not visually recognized substantially.

In the direction DR2, the visual lightness of the color image Pd is increased since half of the color image Pd produces the reflected light LGa. However, even in the presence of the diffusely reflected light LGb, the visual lightness of the color image Pd is just a little higher than half of the visual lightness of the watermark transfer image Pt, the entire region of which produces the reflected light LGa. Accordingly, the difference ΔPt8 therebetween is large, and the watermark transfer image Pt is visually well-recognized as the positive gloss state.

When the color image Pd has a low lightness and the basic transfer pattern PtS is not used, the watermark transfer image Pt transitions between two states where the watermark transfer image Pt is visible or invisible, depending on the viewing direction, thus giving a watermark effect.

Even when the basic transfer pattern PtS is used, in the direction DR2, the difference ΔPt8 in visual lightness between the watermark transfer image Pt and color image Pd is smaller than the difference ΔPt6 when the basic transfer pattern PtS is not used. However, the difference ΔPt8 is enough for the watermark transfer image Pt to be visually recognized, so that the watermark effect of the watermark transfer image Pt can be maintained.

When the color image Pd has a low lightness, as described above, the watermark transfer image Pt transitions between two states where the watermark transfer image Pt is visible or invisible, depending on the viewing direction, regardless of whether the basic transfer pattern PtS is applied, thus giving a good watermark effect. Moreover, the state in which the watermark transfer image Pt is visible is the positive gloss state, with a large difference in visual lightness between the watermark transfer image Pt and the color image Pd as the background. The watermark effect therefore is of a high quality.

Next, a description is given of a case where the color image Pd has a medium lightness (a medium density) with reference to FIGS. 32 and 33.

When the lightness is medium and the basic transfer pattern PtS is not used as illustrated in FIG. 32, the visual lightness of the color image Pd is medium and approximately constant independently of the viewing direction. The visual lightness of the watermark transfer image Pt changes greatly depending on the viewing direction.

In the direction DR1, the visual lightness of the watermark transfer image Pt is lower than that of the color image Pd, and the watermark transfer image Pt is visually recognized as the negative gloss state by the difference ΔPt9. The difference ΔPt9 is large enough for the watermark transfer image Pt to be visually recognized as the negative gloss state.

In the direction DR2, the visual lightness of the watermark transfer image Pt is significantly increased, and is much larger than the visual lightness of the color image Pd. The watermark transfer image Pt is therefore visually recognized as the positive gloss state by the difference ΔPt10.

On the other hand, when the visual lightness is medium and the basic transfer pattern PtS is used as illustrated in FIG. 33, the visual lightness of the color image Pd varies depending on the viewing direction, in the same manner as the case where the color image Pd has a high lightness.

In the direction DR1, the visual lightness of the color image Pd is approximately the same as that of the watermark transfer image Pt, which is medium between those when the color image Pd has a high lightness and a low lightness. The difference ΔPt11 therebetween is small, and the watermark transfer image Pt is not visually recognized substantially.

In the direction DR2, the visual lightness of the color image Pd is a medium value between those when the color image Pd has a high lightness and a low lightness. The difference ΔPt12 therebetween has a certain magnitude, and the watermark transfer image Pt is therefore visually recognized as the positive gloss state.

As described above, when the color image Pd has a medium lightness and the substrate transfer pattern PtS is not used, the watermark transfer image Pt is visually recognized independently of the viewing direction. Accordingly, the watermark effect is not provided.

On the other hand, applying the basic transfer pattern PtS produces two states where the watermark transfer image Pt is visible or invisible depending on the viewing direction, giving a good watermark effect. Moreover, the above state in which the watermark transfer image Pt is visible is the positive gloss state, with a large difference in visual lightness between the watermark transfer image Pt and the color image Pd as the background. The watermark effect therefore is of a high quality.

As described above, by applying the basic transfer pattern PtS to the transfer of the color image Pd, the watermark transfer image Pt provides a good watermark effect independent of the lightness of the color image Pd as the background image.

When the basic transfer pattern PtS is applied to the transfer of the color image Pd, about half of the area of the color image Pd is occupied by the metal ink transferred section Ac. Depending on the contents of the color image Pd, the appearance of the colors in the viewing direction is different from that obtained without the basic transfer pattern PtS, to such an extent that adjustment in terms of brightness is required. For example, the inclusion of the metal ink transferred section Ac could cause colors to look darker than needed in the direction DR1.

Therefore, as described with reference to FIG. 12, the transfer pattern CP can be selected from the plural transfer patterns CPB to CPE in addition to the normal transfer pattern CPA, so that the color appearance can be adjusted as desired.

According to the transfer patterns CPB and CPC especially, the yellow ink IY, which has the highest lightness among the yellow, magenta, and cyan inks, is separately transferred to pixels different from the pixels to which the other magenta ink IM and the cyan ink IC are transferred. This facilitates adjustment to cause the color image Pd to be visually recognized as bright.

Moreover, the transfer pattern CPB allows only the yellow ink IY having the highest lightness to be transferred to the metal non-transfer pixels Mgn. This can effectively improve the visual lightness of the color image Pd.

As described above in detail, according to the printer PR in Example 1, in the process of transferring and forming the color image Pd as the background of the watermark transfer image Pt providing the watermark effect, the basic transfer pattern PtS, which evenly disperses and mixes the metal ink transfer pixels, is applied to a region including the watermark transfer image Pt.

Accordingly, a watermarked color image retransferred and formed on the transfer body such as a card transitions between a state where the watermark transfer image is visible, and a state where the watermark transfer image is invisible, depending on the viewing direction regardless of lightness (density) of the color image Pd as the background, thus providing a good watermark effect.

According to the printer PR in Example 1, the visible state is always the positive gloss state with a large enough difference in lightness between the watermark image and the background. This can provide a high-quality watermark effect.

According to the printer PR in Example 1, it is possible to manufacture a card with a good watermarked color image formed on the surface thereof.

### Example 2

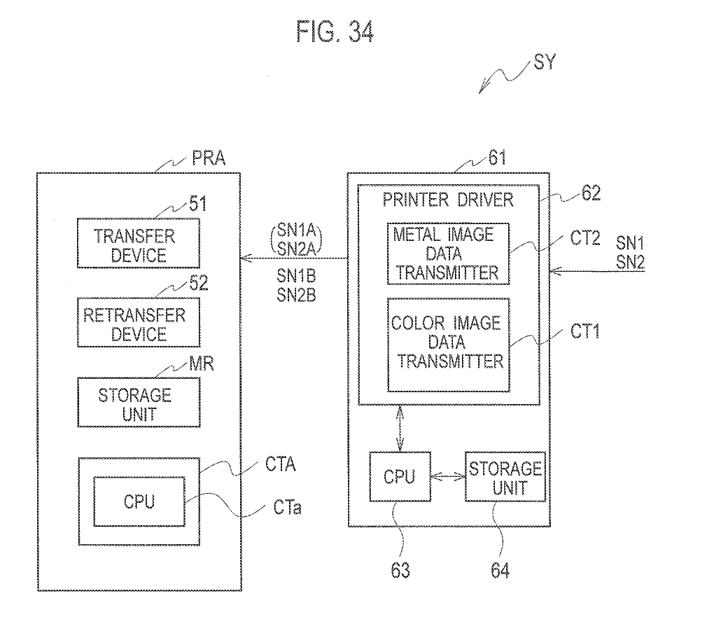

In the printer PR in Example 1, the image data transmitter CTb is provided for the controller CT. However, the printer of the invention is not limited to the configuration in Example 1. The image data transmitter CTb may be included in the external computer 61, which constitutes a printing system together with the printer. In Example 2, the printing system SY is described as an example of the printing system. FIG. 34 illustrates a schematic configuration of the printing system SY.

The printing system SY includes the printer PRA and the computer 61. The printer PRA differs from the printer PR in Example 1 by including the controller CTA, which does not include the image data transmitter CTb, instead of the controller CT. The printer PRA includes the controller CTA, including a central processing unit CTa, the storage unit MR, the transfer device 51, and the retransfer device 52.

On the other hand, the computer 61 includes a central processing unit 63, a storage unit 64, and a printer driver 62 for driving the printer PRA. The computer 61 is configured to execute the operation to send image data to the printer PRA under control of the central processing unit 63, based on a printer driver program.

The printer driver 62 includes a block corresponding to the image data transmitter CTb in the printer PR. The printer driver 62 includes the color image data transmitter CT1 and the metal image data transmitter CT2.

The color transfer image data SN1A and SN1B are created by the color image data transmitter CT1 of the printer driver 62. The metal transfer image data SN2A and the watermark transfer image data SN2B are created by the metal image data transmitter CT2.

The color transfer image data SN1A and SN1B, the metal transfer image data SN2A, and the watermark transfer image data SN2B are sent to the printer PRA by wire or wirelessly.

The printer PRA and the computer 61 are connected via the Internet, for example.

The creation of the color transfer image data SN1B and the watermark transfer image data SN2B in the computer 61 and the transfer operation and retransfer operation in the printer PRA do not need to be executed successively.

The methods of creating the color transfer image data SN1B and the watermark transfer image data SN2B are the same as those in Example 1. The transfer and retransfer operations in the printer PRA are the same as those of the printer PR in Example 1, and provide the same effects as those in Example 1.

The present invention is not limited to the configurations and procedures in Examples 1 and 2, and can be changed without departing from the scope of the present invention.

The basic transfer pattern PtS is preferably the aforementioned checkerboard pattern, but it is not limited to the checkerboard pattern. The basic transfer pattern PtS only needs to be a pattern in which the metal transfer pixels Mgy and metal non-transfer pixels Mgn are dispersed and evenly mixed.

The basic transfer pattern PtS does not need to be applied to the entire region of the color image Pd. The basic transfer pattern PtS needs to be applied to at least the region around the watermark transfer image Pt.

The watermark transfer image Pt may include plural watermark transfer images Pt in the color image Pd. In this case, the basic transfer pattern PtS is applied to a region including the plural watermark transfer images Pt, or to a region corresponding to each watermark transfer image Pt.

In the latter case, the transfer patterns CP for the respective regions can be the same or can be different from each other, depending on the contents of the background image or the contents of the respective watermark transfer images Pt.

In the above description, the ink ribbon includes the ink layers of four colors in total, including three color (yellow, magenta, and cyan) inks, and metal ink. However, the ink ribbon may include ink layers of five colors in total, including four color (yellow, magenta, cyan, and black) inks, and metal ink.

The operation in the case of using the ink ribbon including the five color ink layers can be executed in the same manner as in the case of using the ink ribbon 11 of four colors, except for the execution of an additional operation to transfer and superimpose black ink.

The printers PR and PRA are retransfer printers, but may be transfer devices which manufacture a product (a printed matter such as a card) including an image formed by transfer from the ink ribbon 11, without using the retransfer unit ST1.

To be specific, for example, the printer of the present invention may be a transfer device which cuts out the frames F of the intermediate transfer film 21 with an image transferred thereon into a predetermined shape such as film cards. The printer may be a transfer device which directly transfers an image to the transfer body, such as a card, instead of the intermediate transfer film 21.

When the transfer body to which each ink from the ink ribbon 11 is transferred and superimposed transmits light, in the transfer devices that produce a product without performing retransfer, the metal ink is transferred after the color inks are transferred in the same manner as the transfer operation in the printers PR and PRA. This allows a glossy image to be visually recognized when the transfer body is seen from the opposite side to the surface on which the images are transferred.

On the other hand, when the transfer body to which each ink from the ink ribbon 11 is transferred and superimposed does not transmit light, the metal ink for a glossy image is transferred first, and the color ink of each color image is then transferred. The formed image therefore has a structure in which the metal ink is laid on the side closest to the transfer body, and the color inks are laid on the metal ink. This allows the glossy image to be visually recognized when the transfer body is seen from the side to which the images are transferred.

What is claimed is:

1. A printer comprising:
an input unit configured to receive first image data corresponding to a watermark image by a first glossy ink;
an image data transmitter configured to compose the first image data and data representing a basic transfer pattern as a background of the watermark image to create and send second image data representing a watermark composite image, the basic transfer pattern being configured to transfer the first ink so that first pixels to which the first ink is transferred and second pixels to which the first ink is not transferred are dispersedly mixed; and
a printing unit configured to print a third image based on third image data printed using a second ink on a print body, and to print the watermark composite image based on the second image data using the first ink on the print body to form a watermarked image including the third image and the watermark composite image superimposed on the print body.

2. The printer according to claim 1, wherein the basic transfer pattern is a checkerboard pattern.

3. The printer according to claim 1, wherein
the input unit is configured further to receive fourth image data printed using the second ink, and
the image data transmitter is configured to create the third image data based on the fourth image data and data representing the basic transfer pattern.

4. The printer according to claim 3, wherein the image data transmitter is configured to create the third image data so that when the second ink includes yellow ink, magenta ink, and cyan ink, in the background of the watermark image, the yellow ink is transferred to either the first or second pixels while the magenta ink and cyan ink are transferred to the others.

5. A printing system comprising:
a printer; and
a printer driver configured to send image data to the printer, wherein
the printer driver comprises:
an input unit configured to receive first image data corresponding to a watermark image by a first glossy ink; and
an image data transmitter configured to compose the first image data and data representing a basic transfer pattern as a background of the watermark image to create and send second image data representing a watermark composite image, the basic transfer pattern being configured to transfer the first ink so that first pixels to which the first ink is transferred and second pixels to which the first ink is not transferred are dispersedly mixed; and
the printer comprises
a printing unit configured to print a third image based on third image data printed using a second ink on a print body, and to print the watermark composite image based on the second image data using the first ink on the print body to form a watermarked image including the third image and the watermark composite image superimposed on the print body.

6. A method of manufacturing a printed matter, comprising:
receiving first image data corresponding to a watermark image by a first glossy ink;
composing the first image data and data representing a basic transfer pattern as a background of the watermark image to create second image data representing a watermark composite image, the basic transfer pattern being configured to transfer the first ink so that first pixels to which the first ink is transferred and second pixels to which the first ink is not transferred are dispersedly mixed; and
printing a third image based on third image data printed using a second ink on a print body and printing the watermark composite image based on the second image data using the first ink on the print body to manufacture the printed matter with a watermarked image formed thereon, the watermarked image including the third image and the watermark composite image superimposed on the print body.
